(19) United States
(12) Patent Application Publication
(10) Pub. No.: US 2020/0026206 A1
(43) Pub. Date: Jan. 23, 2020

(54) PHOTOSENSITIVE BODY FOR ELECTROPHOTOGRAPHY, METHOD FOR PRODUCING THE SAME, AND ELECTROPHOTOGRAPHIC DEVICE INCLUDING THE SAME

(71) Applicant: FUJI ELECTRIC CO., LTD., Kawasaki-shi (JP)

(72) Inventors: Hirotaka KOBAYASHI, Matsumoto-city (JP); Yutaka IKEDA, Shenzhen (CN); Yuji OGAWA, Shenzhen (CN); Masaru TAKEUCHI, Matsumoto-city (JP)

(73) Assignee: FUJI ELECTRIC CO., LTD., Kawasaki-shi (JP)

(21) Appl. No.: 16/588,251

(22) Filed: Sep. 30, 2019

Related U.S. Application Data
(63) Continuation of application No. PCT/JP2017/037751, filed on Oct. 18, 2017.

(51) Int. Cl. G03G 5/047; G03G 15/18; G03G 15/08; G03G 5/06; G03G 5/147

(52) U.S. Cl. CPC G03G 5/047; G03G 15/18; G03G 15/0808; G03G 5/0631; G03G 5/14721; G03G 5/0618; G03G 5/0635; G03G 5/0648; G03G 5/14704; G03G 5/0614

(57) ABSTRACT

The present invention provides an electrophotographic photoreceptor including a photosensitive layer containing an electron transport material, and having high pressure resistance and suppressed occurrence of a leak phenomenon, a method for producing the same, and an electrophotographic device using the same. The electrophotographic photoreceptor includes an electrically conductive support containing an aluminum alloy; an anodic oxide film formed on a surface of the electrically conductive support; and a photosensitive layer formed on the anodic oxide film. The photosensitive layer contains an electron transport material having an electron mobility of 10⁻⁷ cm²/V/sec or more when field intensity is set to 20 V/μm. The surface of the electrically conductive support having the anodic oxide film formed thereon has an admittance value that is 25 μS or more and 60 μS or less.

### CROSS-REFERENCE TO RELATED APPLICATION(S)

This non-provisional application for a U.S. Patent is a Continuation of International Application PCT/JP2017/037751 filed Oct. 18, 2017, the entire contents of which is hereby incorporated by reference.

### BACKGROUND OF THE INVENTION

### 1. Field of the Invention

The present invention relates to an electrophotographic photoreceptor (hereinafter, also simply referred to as a “photoreceptor”) which is used in a printer, a copying machine or a facsimile machine employing an electrophotographic system, a method of producing the same, and an electrophotographic device.

### 2. Background of the Related Art

An electrophotographic photoreceptor includes: an electrically conductive support; and a photosensitive layer provided on the electrically conductive support and having a photoconductive function. In recent years, research and development have been actively carried out on organic electrophotographic photoreceptors in which organic compounds are used as functional components responsible for generation and transport of electric charges, because of their advantages in material diversity, high productivity, safety and the like, and the applications of these organic electrophotographic photoreceptors in copying machines and printers are in progress.

In general, a photoreceptor needs to have: a function of retaining surface charges in a dark place; a function of receiving light and generating electric charges; and further, a function of transporting the generated electric charges. As such a photoreceptor, there are known a so-called monolayer photoreceptor, which includes a monolayer photosensitive layer having all of the above described functions; and a so-called laminated (function-separated) photoreceptor, which includes a photosensitive layer obtained by laminating layers each having separated functions, namely: a charge generation layer mainly responsible for the function of generating electric charges upon light reception; and a charge transport layer responsible for the function of retaining surface charges in a dark place and the function of transporting the electric charges generated in the charge generation layer upon light reception.

In general, the photosensitive layer is formed by: preparing a coating liquid in which functional materials, such as a charge generation material and a charge transport material, and a resin binder are dissolved or dispersed in an organic solvent; and coating the coating liquid on an electrically conductive support made of an aluminum alloy. Furthermore, recently a photoreceptor produced using an electron transport material as a functional material has also been proposed. For example, Patent Document 1 discloses an electrophotographic photoreceptor, wherein a charge generation layer and a charge transport layer are provided directly or via an intermediate layer on an electrically conductive substrate in this order, and the charge transport layer contains at least a hole transport substance, an electron transport substance and a binder resin.

### RELATED ART DOCUMENT

Patent Document 1: JP2017-97065A.

### Problems to be Solved by the Invention

However, among electron transport materials, particularly a photoreceptor including a photosensitive layer that contains an electron transport material with relatively high electron mobility is problematic in that a leak phenomenon tends to occur due to electron transfer by the electron transport material in the photosensitive layer. Such a problem of the occurrence of the leak phenomenon is significant particularly when it is used for an electrophotographic device having a contact type charging process or transferring process.

Hence, an object of the present invention is to provide an electrophotographic photoreceptor including a photosensitive layer containing an electron transport material, and having high pressure resistance, and suppressed occurrence of a leak phenomenon, a method for producing the same, and an electrophotographic device using the same.

### SUMMARY OF THE INVENTION

### Means for Solving the Problems

The present inventors have found out, as a result of intensive studies, that it is possible to solve the above-mentioned problems by employing the following constitutions, thereby completing the present invention.

Specifically, an electrophotographic photoreceptor according to a first embodiment of the present invention is an electrophotographic photoreceptor including an electrically conductive support containing an aluminum alloy; an anodic oxide film formed on a surface of the electrically conductive support; and a photosensitive layer formed on the anodic oxide film, wherein the photosensitive layer contains an electron transport material having an electron mobility of 10⁻⁷ cm²/V/sec or more when field intensity is set to 20 V/μm, and wherein the surface of the electrically conductive support having the anodic oxide film has an admittance value that is 25 μS or more and 60 μS or less.

Further, a method for producing an electrophotographic photoreceptor according to a second embodiment of the present invention is a method for producing the above electrophotographic photoreceptor, comprising: forming the anodic oxide film on the surface of the electrically conductive support using anodic oxidation; and exposing the electrically conductive support after anodic oxidation to a steam atmosphere as a post-treatment, wherein the steam atmosphere in the post-treatment is present in a quantity effective to provide 60 RH %·h or more. Here, the quantity of the steam atmosphere is a value represented by the ratio of (a) total steam quantity ((g/m³)·RH %·h) in the steam atmosphere, which is represented by a product of steam quantity per unit volume ((g/m³)·RH %), which is the product of a quantity of saturated steam (g/m³) times relative humidity (RH %) in the steam atmosphere times a processing time (h) of the post-treatment to (b) the quantity of saturated steam (g/m³) at a temperature of 323K.

Furthermore, an electrophotographic device according to a third embodiment of the present invention is an electrophotographic device including the above electrophotographic photoreceptor; a charging device for charging the electrophotographic photoreceptor; and a transferring device for transferring an electrophotographic image generated on the electrophotographic photoreceptor, wherein the charging device or the transferring device is a contact-type device or both the charging device and the transferring device are contact-type devices.

In this case, the charging device or the transferring device is preferably a positive-charging, contact-type device, or both the charging device and the transferring device are preferably positive-charging, contact-type devices, and the charging device or the transferring device includes a contact-type roller member, or both the charging device and the transferring device include a respective contact-type roller member, and each contact-type roller member has a surface having a linear velocity in a rotation direction that is preferably 200 mm/sec or more.

### Effects of the Invention

According to the present invention, an electrophotographic photoreceptor including a photosensitive layer containing an electron transport material and having high pressure resistance and suppressed occurrence of a leak phenomenon, a method for producing the same and an electrophotographic device using the same could be obtained.

### BRIEF DESCRIPTION OF THE DRAWINGS

FIG. 1 is a schematic sectional view showing a negatively-charged laminated electrophotographic photoreceptor as an example of the electrophotographic photoreceptor of the present invention;

FIG. 2 is a schematic sectional view showing a positively-charged monolayer electrophotographic photoreceptor as another example of the electrophotographic photoreceptor of the present invention;

FIG. 3 is a schematic sectional view showing a positive charging laminated electrophotographic photoreceptor, which is another example of the electrophotographic photoreceptor of the present invention;

FIG. 4 is a schematic diagram showing an example of the electrophotographic device of the present invention; and

FIG. 5 is an explanatory diagram showing transfer of electric charges in the negatively-charged photoreceptor.

### DETAILED DESCRIPTION OF THE INVENTION

Specific embodiments of the present invention will now be described in detail, with reference to drawings. The present invention is in no way limited by the following description.

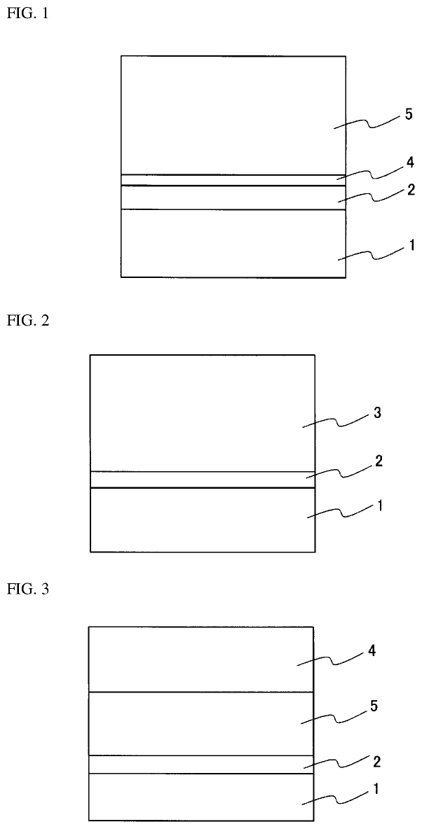

As described above, electrophotographic photoreceptors are roughly classified into: so-called negatively-charged laminated photoreceptors and positively-charged laminated photoreceptors, as laminated (function-separated) photoreceptors; and monolayer photoreceptors mainly used as positively-charged photoreceptors. FIGS. 1 to 3 are schematic sectional views each showing one example of the electrophotographic photoreceptor according to the present invention. FIG. 1 shows a laminated electrophotographic photoreceptor used in a negatively-charged electrophotographic process. FIG. 2 shows a monolayer electrophotographic photoreceptor used in a positively-charged electrophotographic process. FIG. 3 shows a laminated electrophotographic photoreceptor used in a positively-charged electrophotographic process.

As shown in the figures, in the negatively-charged laminated photoreceptor, an undercoat layer 2; and a photosensitive layer including a charge generation layer 4 having a charge generation function and a charge transport layer 5 having a charge transport function; are sequentially laminated on an electrically conductive support 1. Further, in the positively-charged monolayer photoreceptor, an undercoat layer 2; and a monolayer photosensitive layer 3 having both a charge generation function and a charge transport function; are sequentially laminated on an electrically conductive support 1. Still further, in the positively-charged laminated photoreceptor, an undercoat layer 2; and a photosensitive layer including a charge transport layer 5 having a charge transport function and a charge generation layer 4 having both a charge generation function and a charge transport function; are sequentially laminated on an electrically conductive support 1. The photosensitive layer may be an organic photosensitive layer containing an organic compound as a functional component responsible for generation and transport of electric charges.

The electrophotographic photoreceptor of the present invention includes: an electrically conductive support 1 containing an aluminum alloy; an anodic oxide film formed on a surface of the electrically conductive support 1; and a photosensitive layer formed on the anodic oxide film. In the electrophotographic photoreceptor of the present invention, the photosensitive layer contains an electron transport material having an electron mobility of 10⁻⁷ cm²/V/sec or more when field intensity is set to 20 V/μm, and an admittance value of the surface of the electrically conductive support having the anodic oxide film is 25 μS or more and 60 μS or less.

The anodic oxide film provided on the surface of the electrically conductive support 1 and the admittance value (degree of pore sealing) set to 25 μS or more and 60 μS or less make it possible to obtain an electrophotographic photoreceptor with high pressure resistance and suppressed occurrence of a leak phenomenon, even when it includes a photosensitive layer that contains an electron transport material having relatively high electron mobility. If the admittance value is lower than the above range, a step of exposing the electrically conductive support to a steam atmosphere requires high humidity and long storage time, leading to a high utility cost. If the admittance value is higher than the above range, the pressure resistance decreases, so that the leak phenomenon cannot be suppressed.

An example of a means for adjusting the admittance value of the electrically conductive support 1 within the above predetermined range is to perform post-treatment of exposing the electrically conductive support after the anodic oxidation treatment to a steam atmosphere. The electrically conductive support on which the anodic oxide film is formed is placed under a steam atmosphere, so that the admittance value can be decreased. Accordingly, through adequate selection of the temperature and relative humidity of the steam atmosphere, and the retention time under the steam atmosphere, the admittance value can be easily adjusted within the above range.

Note that an admittance value can be measured in accordance with JIS H8683-3:2013 using ANOTEST® (manufactured by Helmut Fischer GmbH), for example.

In the photoreceptor of the present invention, the electrically conductive support 1 is required to have an anodic oxide film and an admittance value satisfying the above specified range, and this enables to obtain the expected effects of the present invention. The configurations of the constituents other than the electrically conductive support 1 are not particularly limited, and can be selected as appropriate.

The electrically conductive support 1 serves as an electrode of a photoreceptor, and at the same time, serves as a support for respective layers constituting the photoreceptor. The electrically conductive support 1 may have any shape, such as a cylindrical shape, a plate-like shape or a film-like shape. The electrically conductive support 1 is not particularly limited, as long as it contains an aluminum alloy, and for example, A1050, A3003, A5052, A5056, A6061, A6063, and the like can be used. The aluminum alloy may be an aluminum alloy having a purity of 99.00% or more, an alloy obtained by adding manganese to aluminum, an alloy obtained by adding magnesium to aluminum, or an alloy obtained by adding magnesium and silicon to aluminum. The aluminum alloy may contain unavoidable impurities.

The anodic oxidation treatment for the electrically conductive support 1 can be performed according to a standard method and is not particularly limited. For pore sealing treatment after the anodic oxidation treatment, pure water or nickel acetate can be suitably used. The film thickness of the anodic oxide film is not particularly limited and can be 2 μm or more and 15 μm or less, for example.

In the photoreceptor according to the embodiment of the present invention, the anodic oxide film formed on the electrically conductive support 1 corresponds to an undercoat layer 2, and furthermore, a layer containing a resin as a main component may be provided as another undercoat layer 2. Examples of the resin material to be used in the undercoat layer 2 include: insulating polymers such as casein, polyvinyl alcohol, polyamide, melamine and cellulose; and conductive polymers such as polythiophene, polypyrrole and polyaniline. These resins can be used singly or in an appropriate combination. Further, these resins may be used containing a metal oxide such as titanium dioxide or zinc oxide.

Moreover, in the photoreceptor of the present invention, the photosensitive layer may have any layer configuration, as long as it contains an electron transport material satisfying predetermined conditions. Specifically, in the photoreceptor of the present invention, the photosensitive layer contains an electron transport material having an electron mobility of 10⁻⁷ cm²/V/sec or more, preferably 1.0×10⁻⁷ cm²/V/sec or more, further preferably 1.0×10⁻⁷ cm²/V/sec or more and 30×10⁻⁷ cm²/V/sec or less, particularly preferably 1.5×10⁻⁷ cm²/V/sec or more and 28×10⁻⁷ cm²/V/sec or less when the field intensity is set to 20 V/μm. Even when such an electron transport material having a relatively high electron mobility is used, the present invention is useful in that a leak phenomenon can be suppressed.

Here, the above electron mobility can be measured using a coating liquid obtained by adding an electron transport material into a resin binder in such a manner that the content is 50% by mass. The ratio of the electron transport material to the resin binder is 50:50. The resin binder may be a bisphenol Z polycarbonate, such as Lupizeta™ PCZ-500 (trade name, manufactured by MITSUBISHI GAS CHEMICAL COMPANY, INC.). Specifically, the coating liquid is applied onto a substrate, the substrate is dried at 120° C. for 30 minutes to prepare a coating film with a film thickness of 7 μm, and then an electron mobility at a fixed field intensity of 20 V/μm can be measured using TOF (Time of Flight) method. The temperature for measurement is 300K.

Examples of the electron transport material satisfying the above range of electron mobility include compounds represented by the following general formulae (ET1) to (ET3), and at least one kind thereof can be used herein.

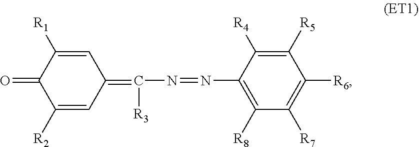

in formula (ET1), R₁ and R₂ are the same or different, and each represents a hydrogen atom, a C1-C12 alkyl group, a C1-C12 alkoxy group, an aryl group which may have a substituent, a cycloalkyl group, an aralkyl group which may have a substituent, or, an alkyl halide group, R₃ represents a hydrogen atom, a C1-C6 alkyl group, a C1-C6 alkoxy group, an aryl group which may have a substituent, a cycloalkyl group, an aralkyl group which may have a substituent, or, an alkyl halide group, R₄ to R₈ are the same or different, and each represents a hydrogen atom, a halogen atom, a C1-C12 alkyl group, a C1-C12 alkoxy group, an aryl group which may have a substituent, an aralkyl group which may have a substituent, a phenoxy group which may have a substituent, an alkyl halide group, a cyano group, or, a nitro group, or, two or more groups may bind to each other to form a ring, and the substituent represents a halogen atom, a C1-C6 alkyl groups, a C1-C6 alkoxy group, a hydroxyl group, a cyano group, an amino group, a nitro group, or an alkyl halide group;

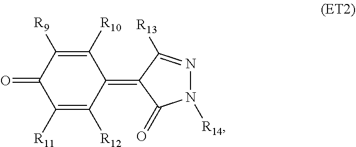

in formula (ET2), R₉ to R₁₄ are the same or different, and each represents a hydrogen atom, a halogen atom, a cyano group, a nitro group, a hydroxyl group, a C1-C12 alkyl group, a C1-C12 alkoxy group, an aryl group which may have a substituent, a heterocyclic group which may have a substituent, an ester group, a cycloalkyl group, an aralkyl group which may have a substituent, an allyl group, an amide group, an amino group, an acyl group, an alkenyl group, an alkynyl group, a carboxyl group, a carbonyl group, a carboxylic acid group, or, an alkyl halide group, the substituent represents a halogen atom, a C1-C6 alkyl group, a C1-C6 alkoxy group, a hydroxyl group, a cyano group, an amino group, a nitro group or an alkyl halide group; and

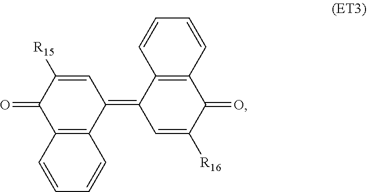

in formula (ET3), R₁₅ and R₁₆ are the same or different, and each represents a hydrogen atom, a halogen atom, a cyano group, a nitro group, a hydroxyl group, a C1-C12 alkyl group, a C1-C12 alkoxy group, an aryl group which may have a substituent, a heterocyclic group which may have a substituent, an ester group, a cycloalkyl group, an aralkyl group which may have a substituent, an allyl group, an amide group, an amino group, an acyl group, an alkenyl group, an alkynyl group, a carboxyl group, a carbonyl group, a carboxylic acid group, or, an alkyl halide group, and the substituent represents a halogen atom, a C1-C6 alkyl group, a C1-C6 alkoxy group, a hydroxyl group, a cyano group, an amino group, a nitro group, or, an alkyl halide group.

Specific examples of the compound represented by the above general formula (ET1) include, but are not limited to, the following compounds.

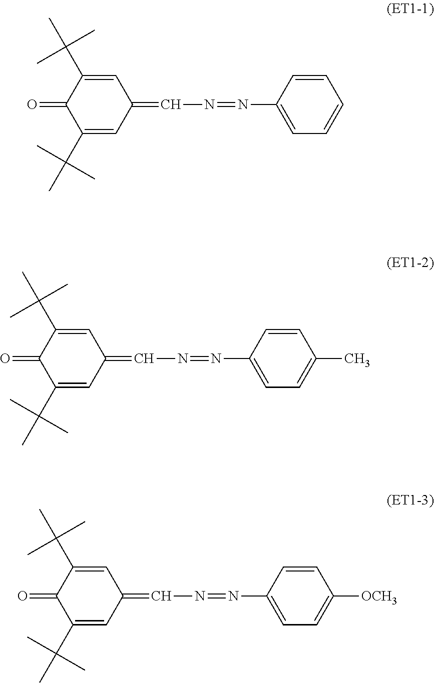

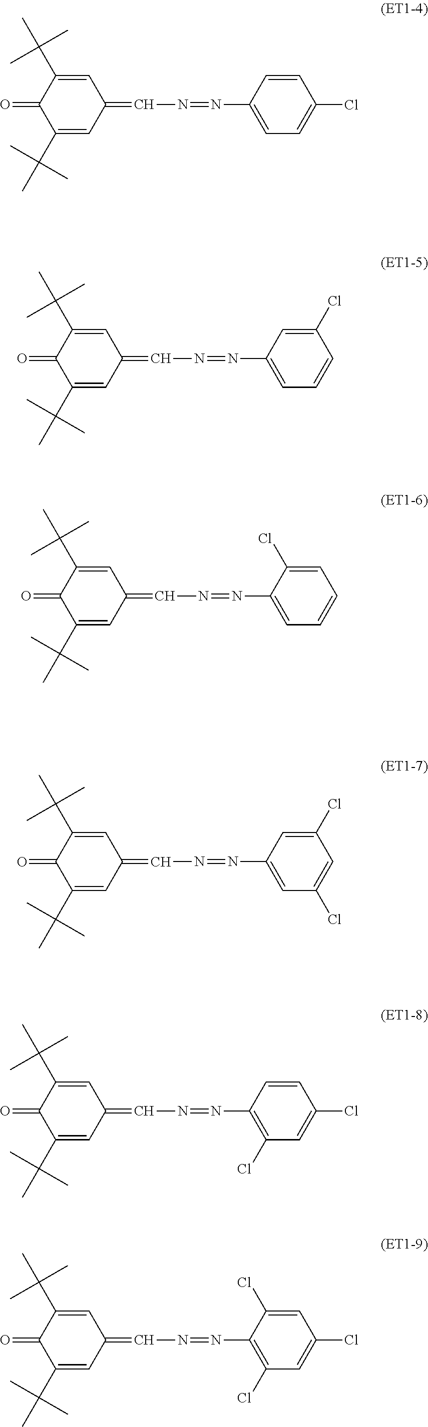

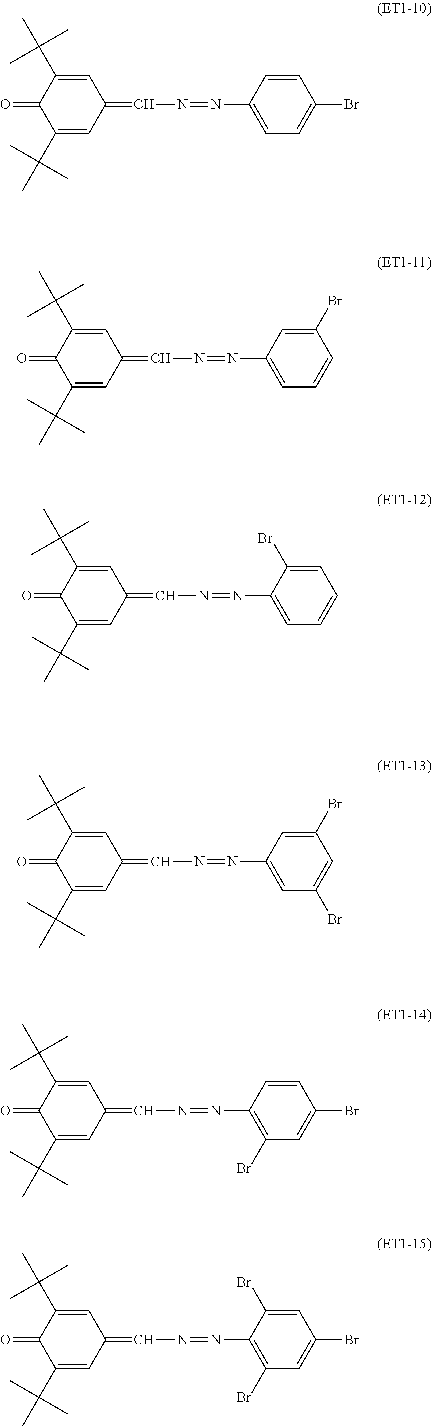

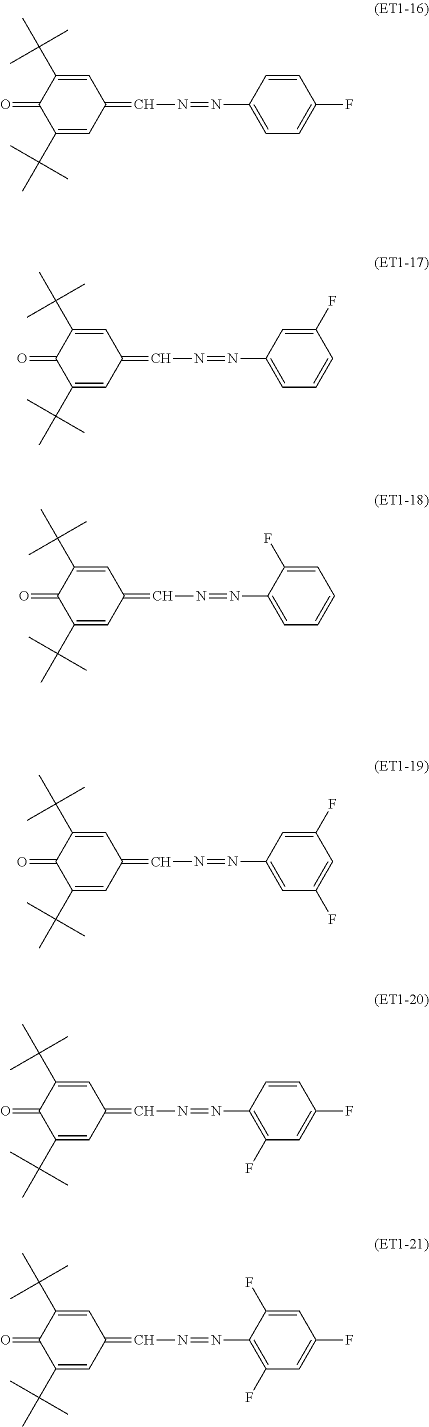

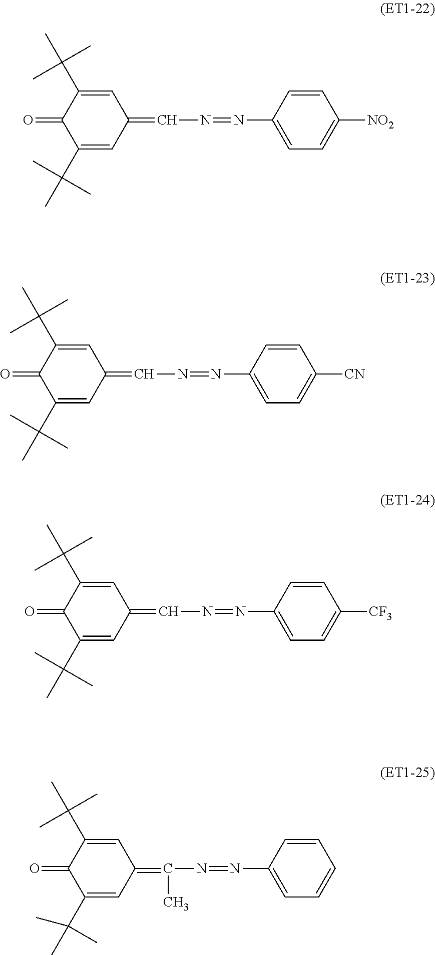

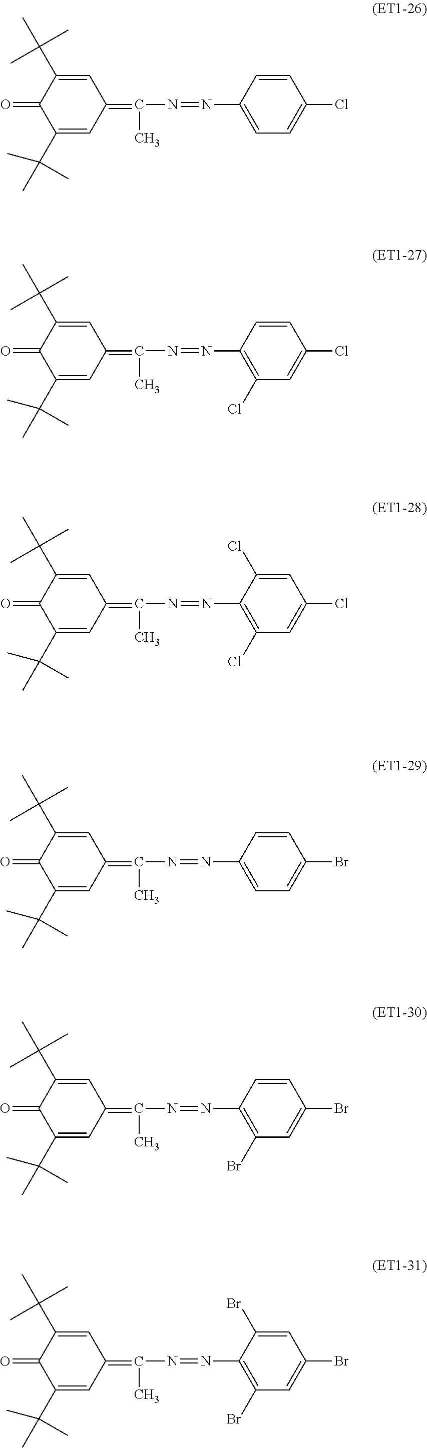

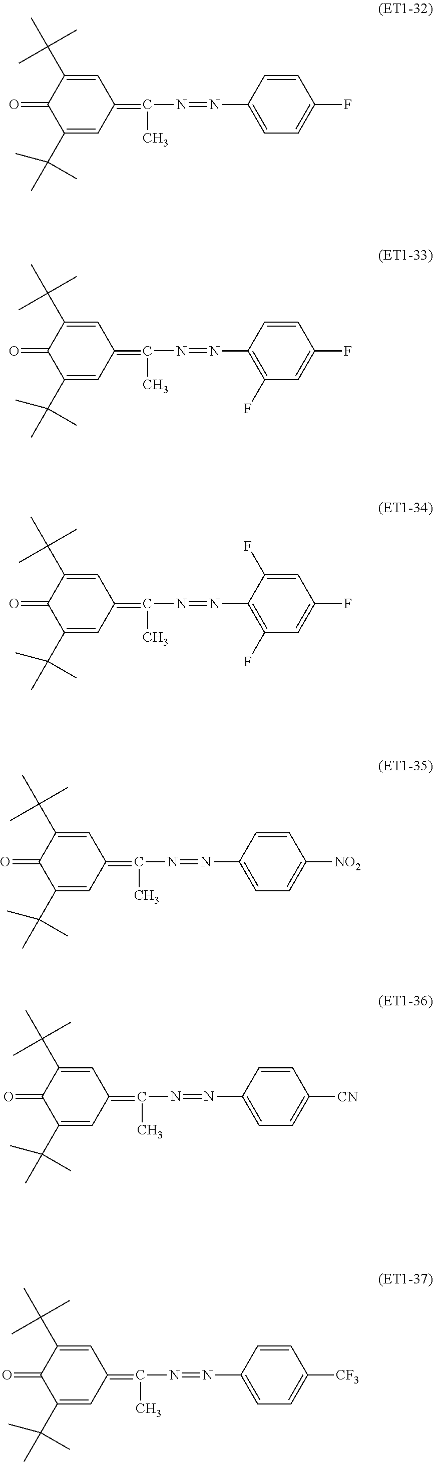

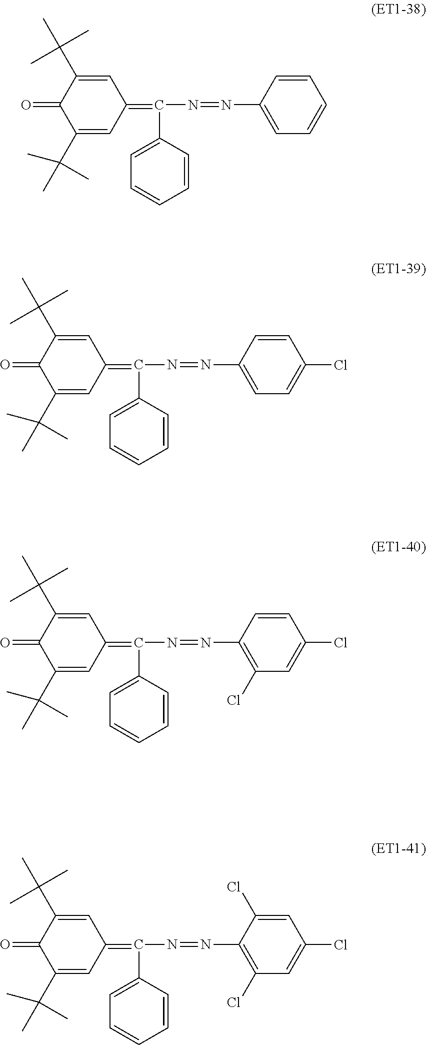

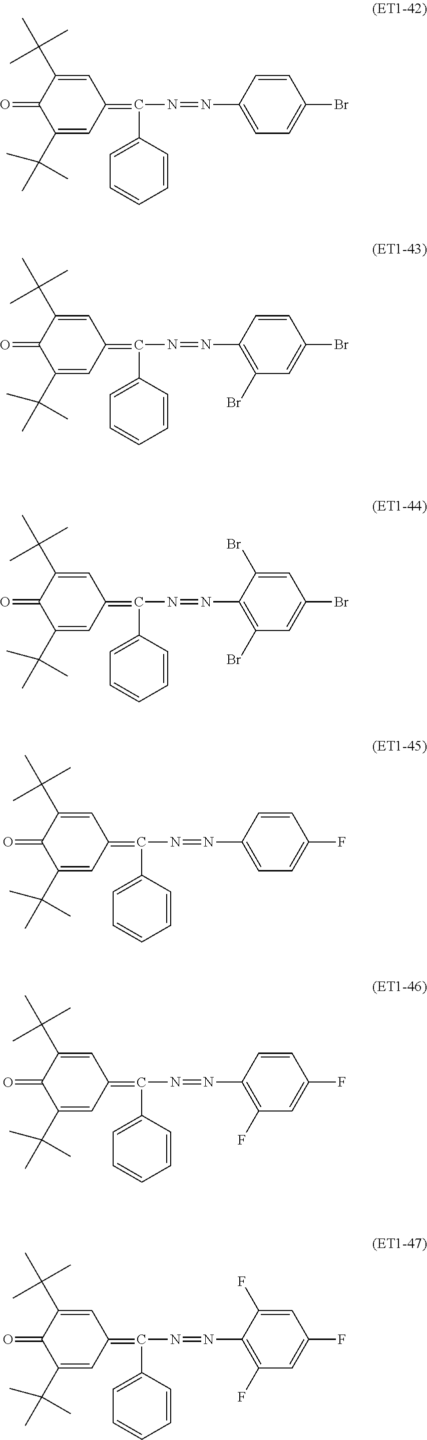

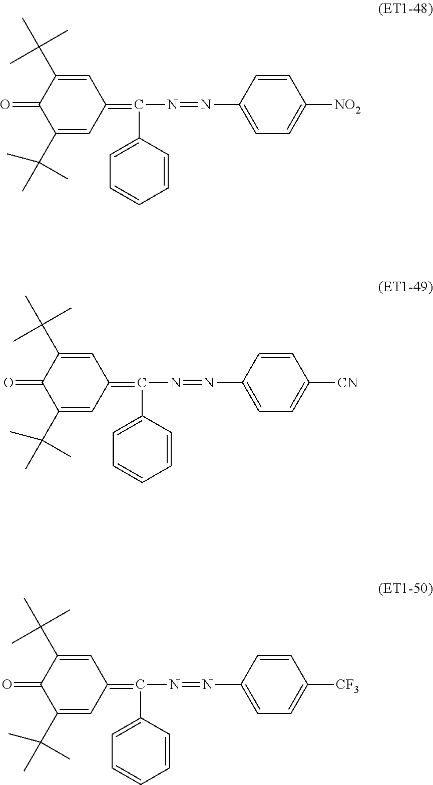

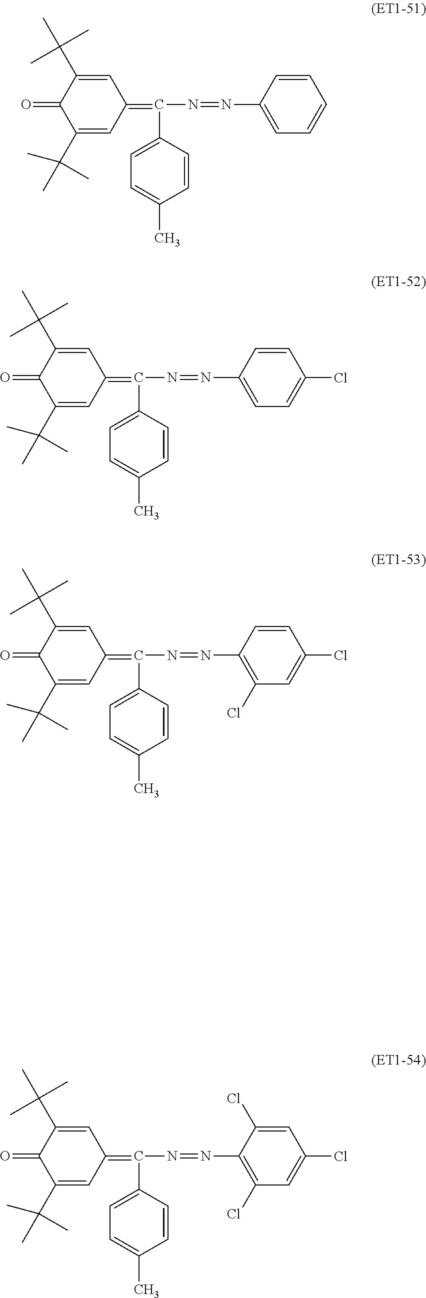

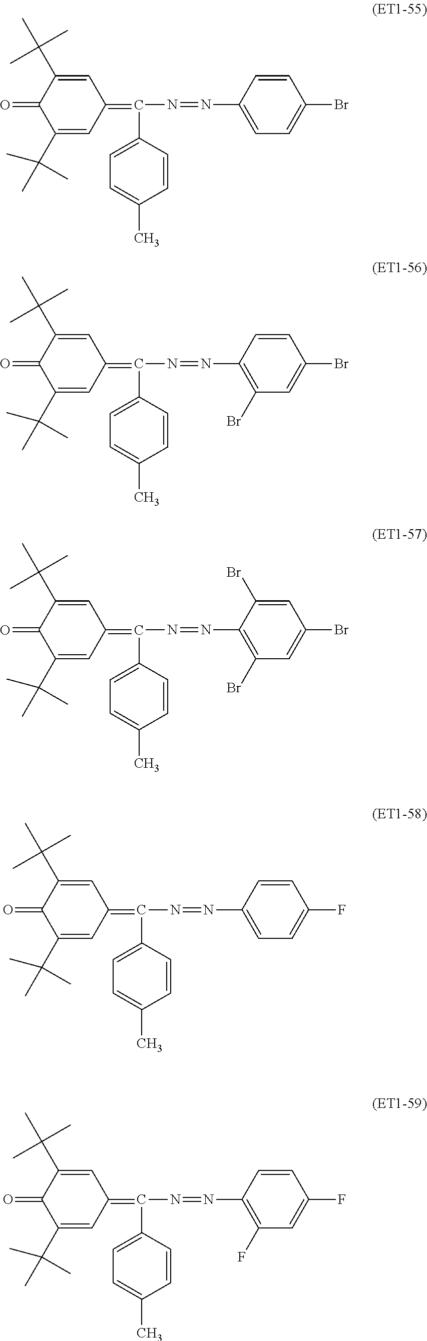

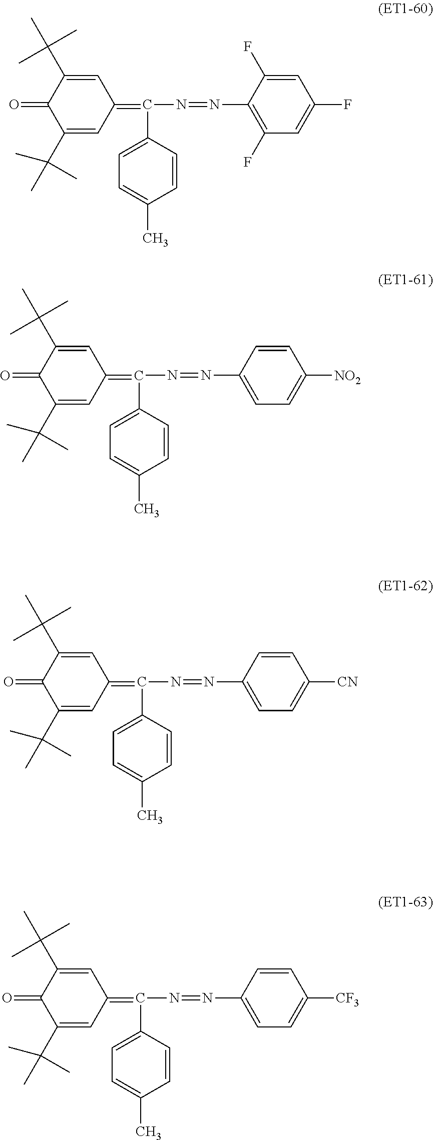

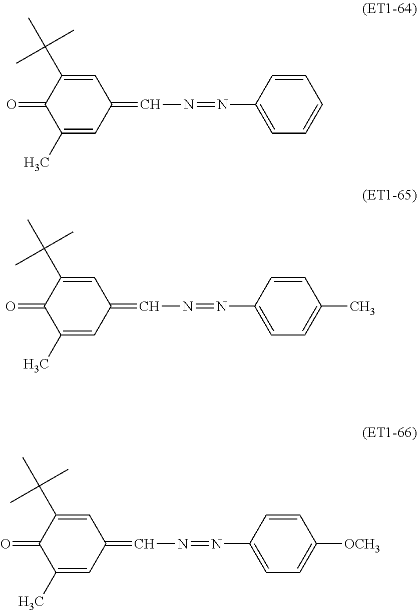

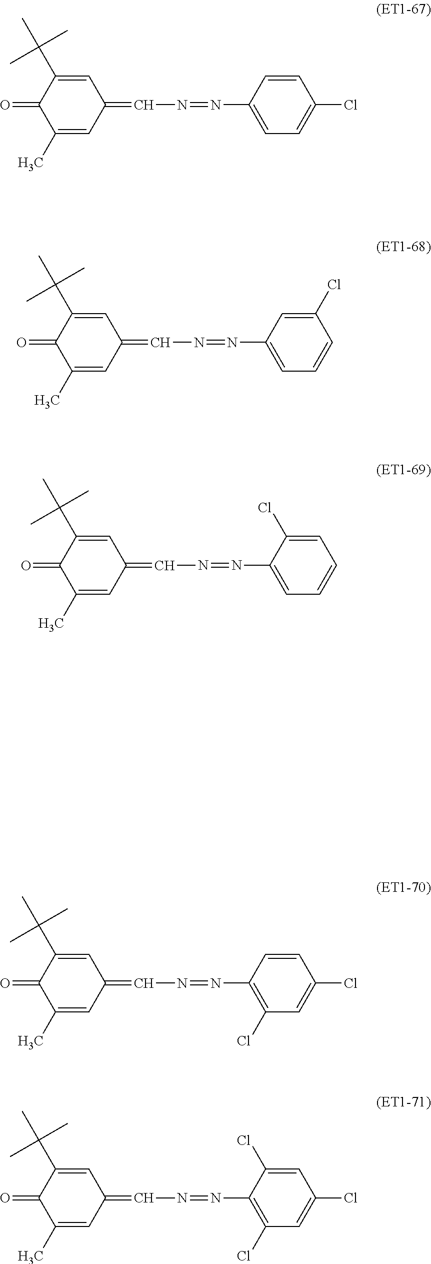

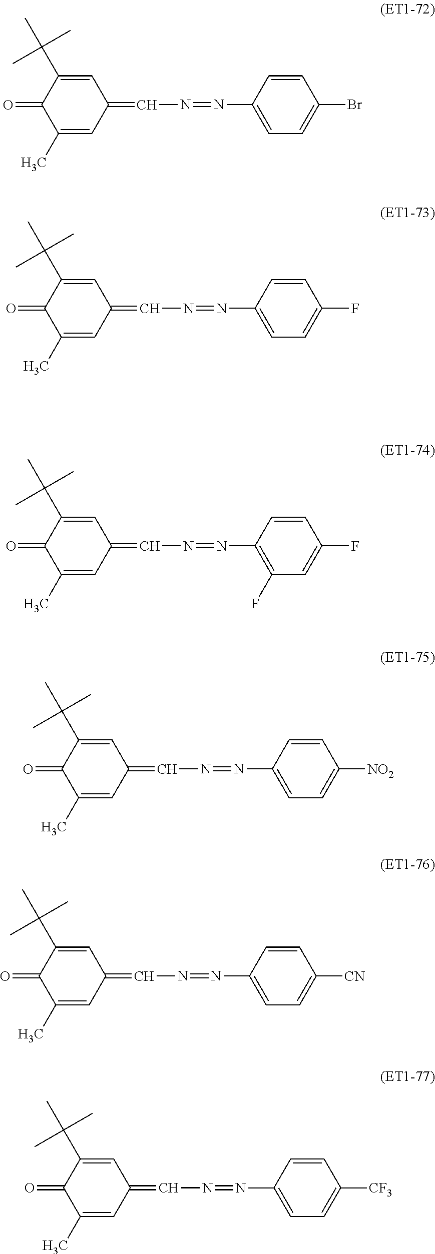

Specific examples of the compound represented by the above general formula (ET2) include, but are not limited to, the following compounds. Note that in general formula (ET2), an aryl group is preferably obtained by substitution of substituent R₁₄ with a halogen group such as a chlorine group, because of the high electron transport capability of the compound.

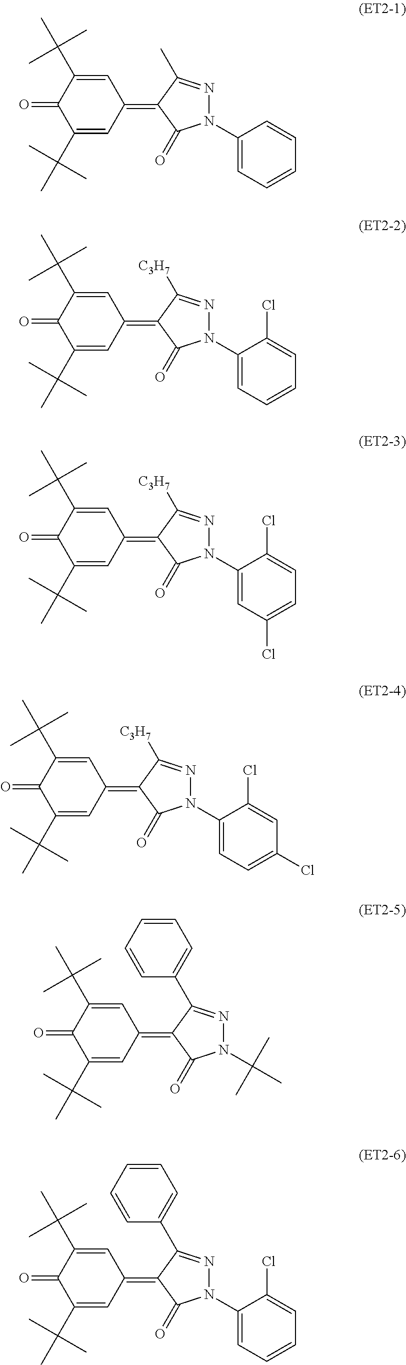

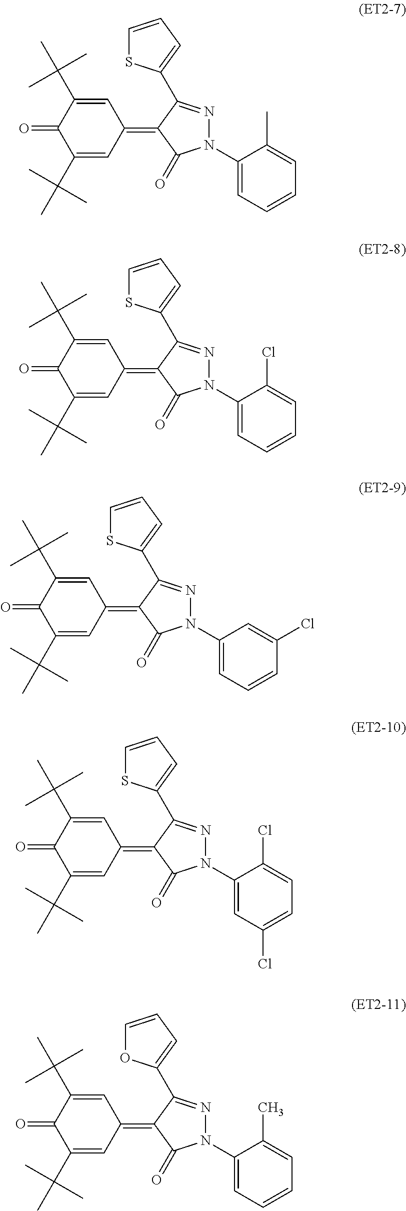

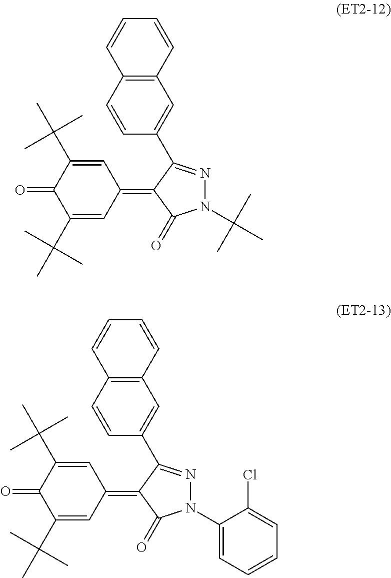

Specific examples of the compound represented by the above general formula (ET3) include, but are not limited to, the following compounds.

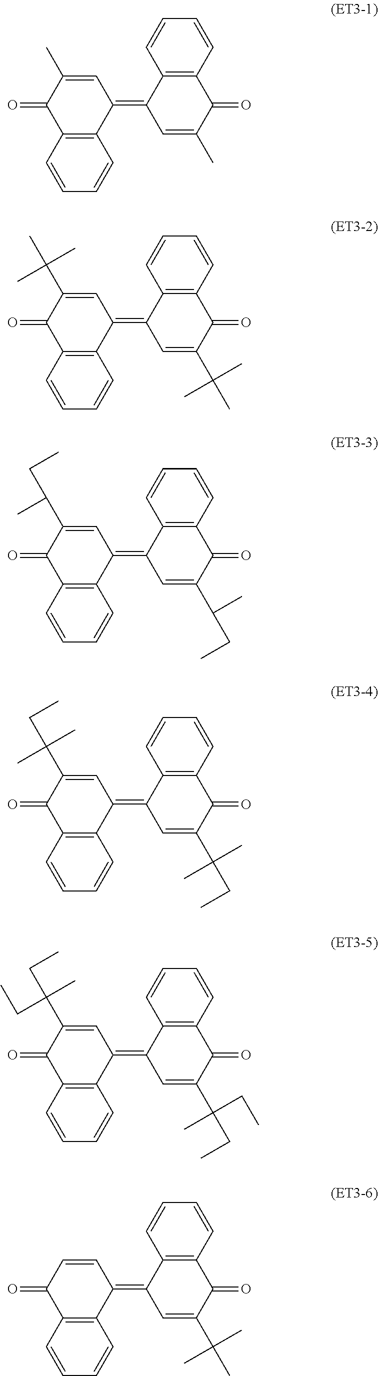

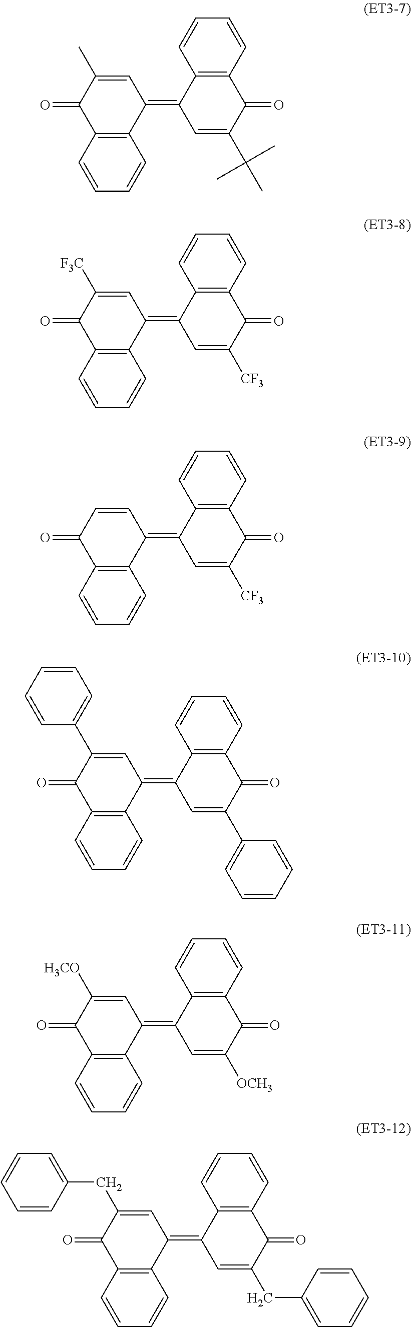

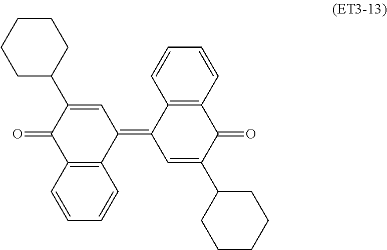

Further examples of the electron transport material include succinic anhydride, maleic anhydride, dibromosuccinic anhydride, phthalic anhydride, 3-nitrophthalic anhydride, 4-nitrophthalic anhydride, pyromellitic anhydride, pyromellitic acid, trimellitic acid, trimellitic anhydride, phthalimide, 4-nitrophthalimide, tetracyanoethylene, tetracyanoquinodimethane, chloranil, bromanil, o-nitrobenzoic acid, malononitrile, trinitrofluorenone, trinitrothioxanthone, dinitrobenzene, dinitroanthracene, dinitroacridine, nitroanthraquinone, dinitroanthraquinone, thiopyran compounds, quinone compounds, benzoquinone compounds, diphenoquinone compounds, naphthoquinone compounds, azoquinone compounds, anthraquinone compounds, diiminoquinone compounds, and stilbenequinone compounds. One kind of or two or more kinds of these electron transport materials can be adequately used in combination.

Negatively-Charged Laminated Photoreceptor:

When the photoreceptor of the present invention is a negatively-charged laminated electrophotographic photoreceptor, the photosensitive layer includes the charge generation layer 4 and the charge transport layer 5 in this order from the side of the electrically conductive support 1.

In the negatively-charged laminated photoreceptor, the charge generation layer 4 is formed, for example, by a method of coating a coating liquid obtained by dispersing particles of a charge generation material in a resin binder, and the thus formed layer 4 receives light and generates electric charges. It is important that the charge generation layer 4 have a high charge generation efficiency, and at the same time, an ability to inject the generated electric charges into the charge transport layer 5. Further, it is desirable that the charge generation layer 4 be less dependent on the electric field and have an effective injectability even at low electric fields.

Examples of the charge generation material include: phthalocyanine compounds such as X-type metal-free phthalocyanine, τ-type metal-free phthalocyanine, α-type titanyl phthalocyanine, β-type titanyl phthalocyanine, Y-type titanyl phthalocyanine, γ-type titanyl phthalocyanine, amorphous titanyl phthalocyanine and ε-type copper phthalocyanine; and pigments such as various types of azo pigments, anthanthrone pigments, thiapyrylium pigments, perylene pigments, perinone pigments, squarylium pigments and quinacridone pigments. These compounds can be used singly or in an appropriate combination, and any suitable substance can be selected depending on the wavelength region of an exposure light source which is used in the image formation. In particular, a phthalocyanine compound can be suitably used. It is also possible to form the charge generation layer 4 using the charge generation material as a main component, and adding thereto a charge transport material and the like.

Examples of the resin binder to be used in the charge generation layer 4 include polymers and copolymers of polycarbonate resins, polyester resins, polyamide resins, polyurethane resins, vinyl chloride resins, vinyl acetate resins, phenoxy resins, polyvinyl acetal resins, polyvinyl butyral resins, polystyrene resins, polysulfone resins, diallyl phthalate resins and methacrylate resins; which can be used in an appropriate combination.

The content of the charge generation material in the charge generation layer 4 is suitably from 20 to 80% by mass, and more suitably from 30 to 70% by mass, with respect to the solid content of the charge generation layer 4. Further, the content of the resin binder in the charge generation layer 4 is suitably from 20 to 80% by mass, and more suitably from 30 to 70% by mass, with respect to the solid content of the charge generation layer 4. Since the charge generation layer 4 is only required to have a charge generation function, the charge generation layer 4 generally has a film thickness of 1 μm or less, suitably 0.5 μm or less.

In the case of the negatively-charged laminated photoreceptor, the charge transport layer 5 is the outermost surface layer of the photoreceptor. In the negatively-charged laminated photoreceptor, the charge transport layer 5 is mainly composed of a hole transport material, an electron transport material and a resin binder.

Examples of the resin binder to be used in the charge transport layer 5 include: polyarylate resins; and various types of polycarbonate resins such as bisphenol A polycarbonates, bisphenol Z polycarbonates, bisphenol C polycarbonates, bisphenol A polycarbonate-biphenyl copolymers and bisphenol Z polycarbonate-biphenyl copolymers. These resins can be used singly, or a plurality of these resins can be used as a mixture. Further, the same kind of resins having different molecular weights may be used as a mixture. Other examples of the resin binder which can be used include polyphenylene resins, polyester resins, polyvinyl acetal resins, polyvinyl butyral resins, polyvinyl alcohol resins, vinyl chloride resins, vinyl acetate resins, polyethylene resins, polypropylene resins, acrylic resins, polyurethane resins, epoxy resins, melamine resins, silicone resins, polyamide resins, polystyrene resins, polyacetal resins, polysulfone resins and methacrylate polymers, and copolymers of these resins.

The above described resin suitably has a weight average molecular weight, as measured by GPC (gel permeation chromatography) analysis in terms of polystyrene, of from 5,000 to 250,000, and more suitably from 10,000 to 200,000.

Further, examples of the hole transport material to be used in the charge transport layer 5 include various types of hydrazone compounds, styryl compounds, diamine compounds, butadiene compounds, indole compounds and aryl amine compounds; and these compounds can be used singly, or can be mixed and used in an appropriate combination. Examples of such a hole transport material include, but not limited to, compounds represented by the following formulae (II-1) to (II-30).

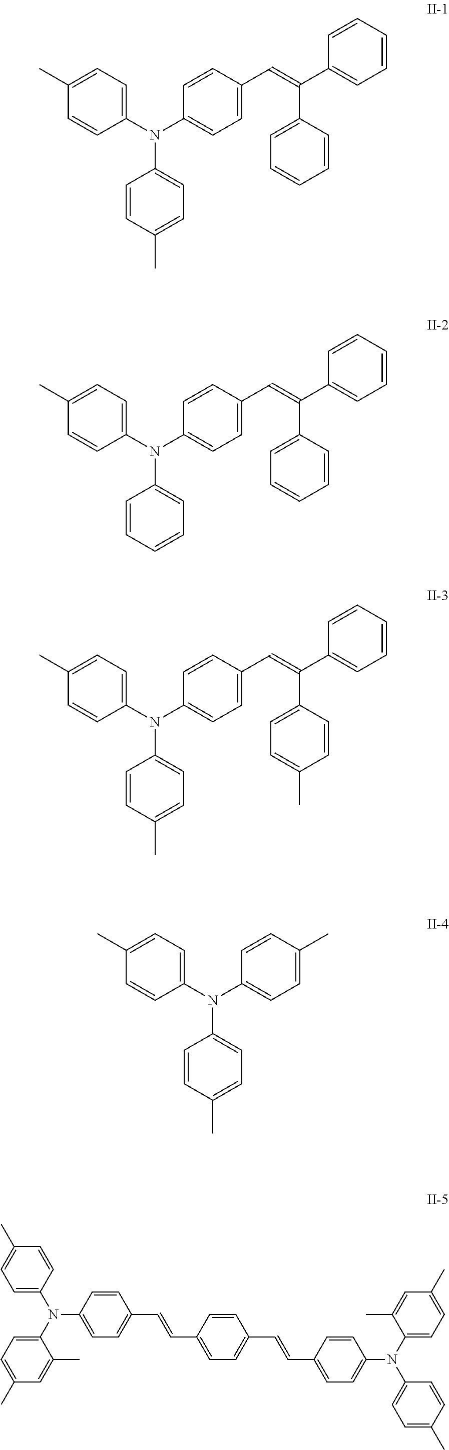

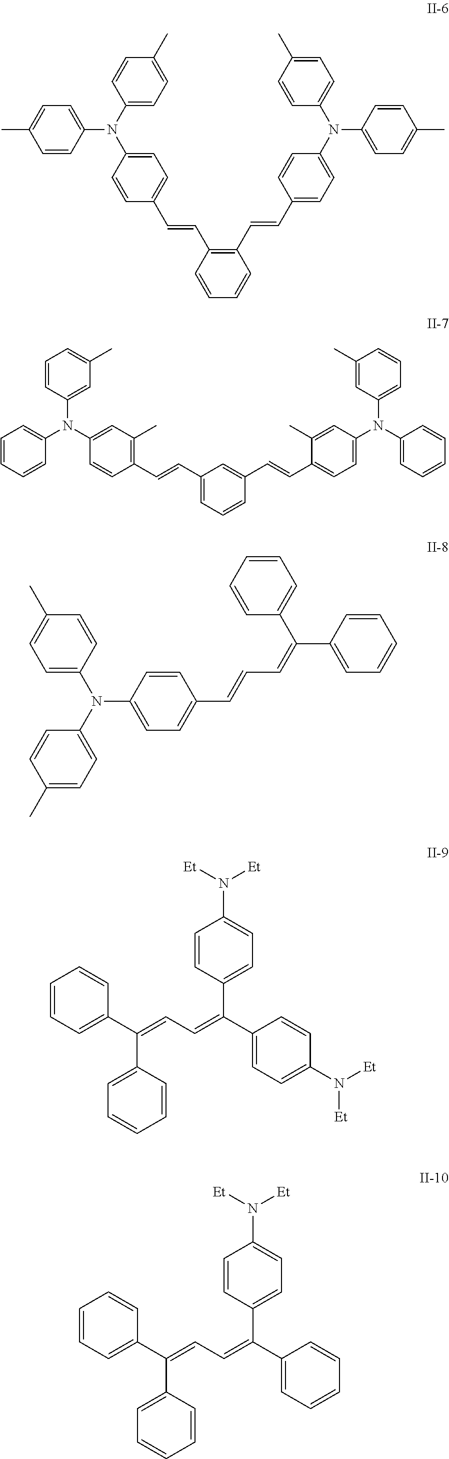

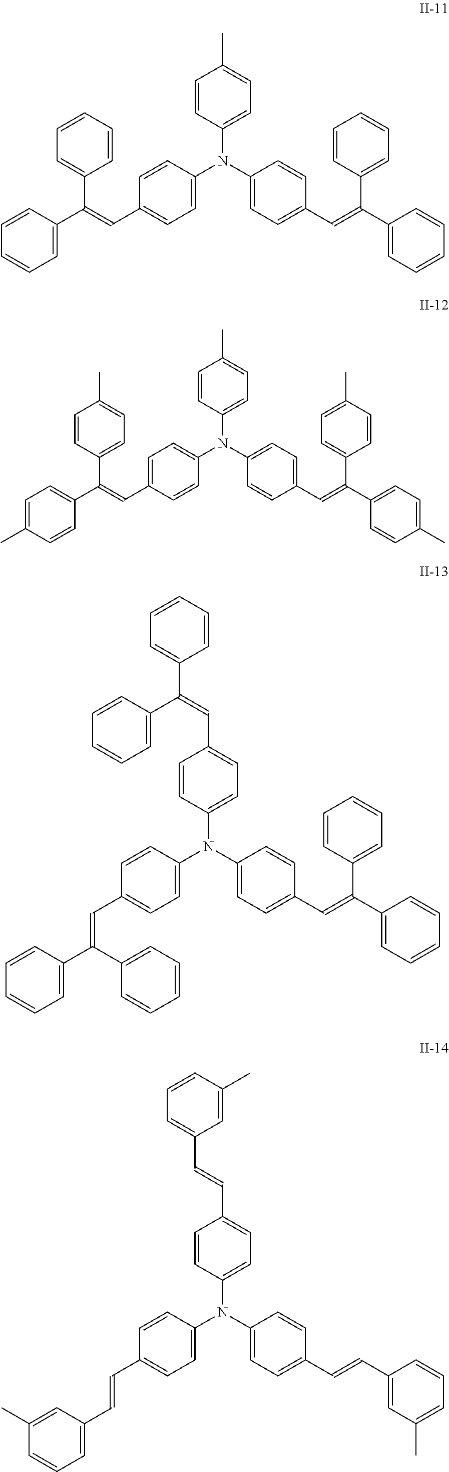

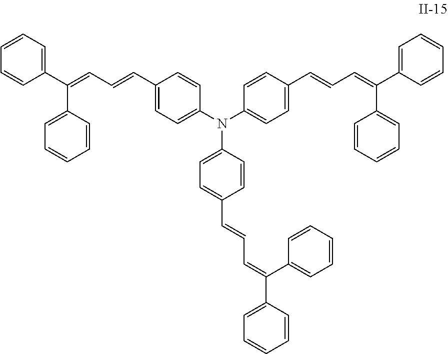 [SMILES: C(/C=C/c1ccc(N(c2ccc(/C=C/C=C(c3ccccc3)c3ccccc3)cc2)c2ccc(/C=C/C=C(c3ccccc3)c3ccccc3)cc2)cc1)=C(c1ccccc1)c1ccccc1]

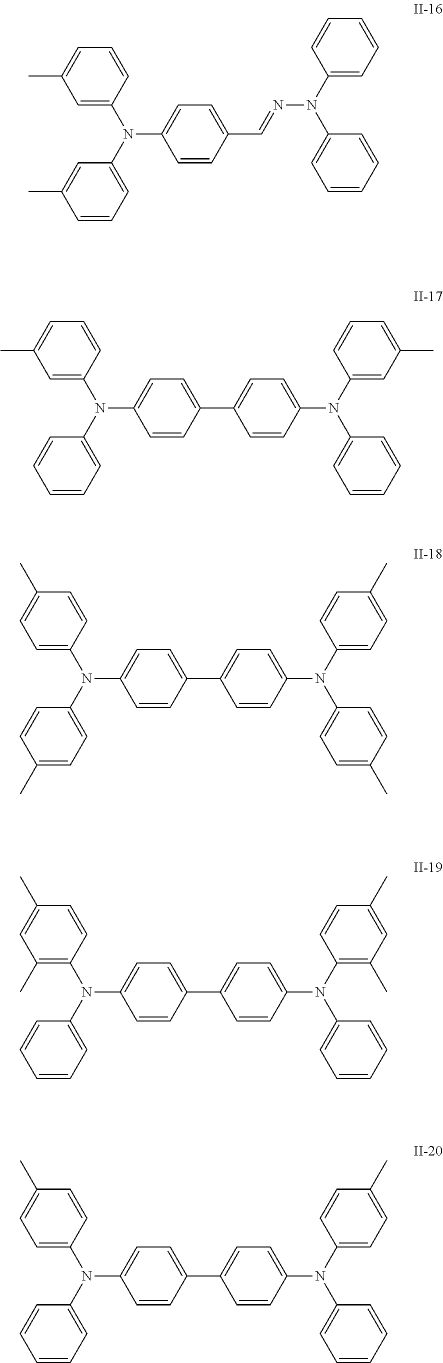

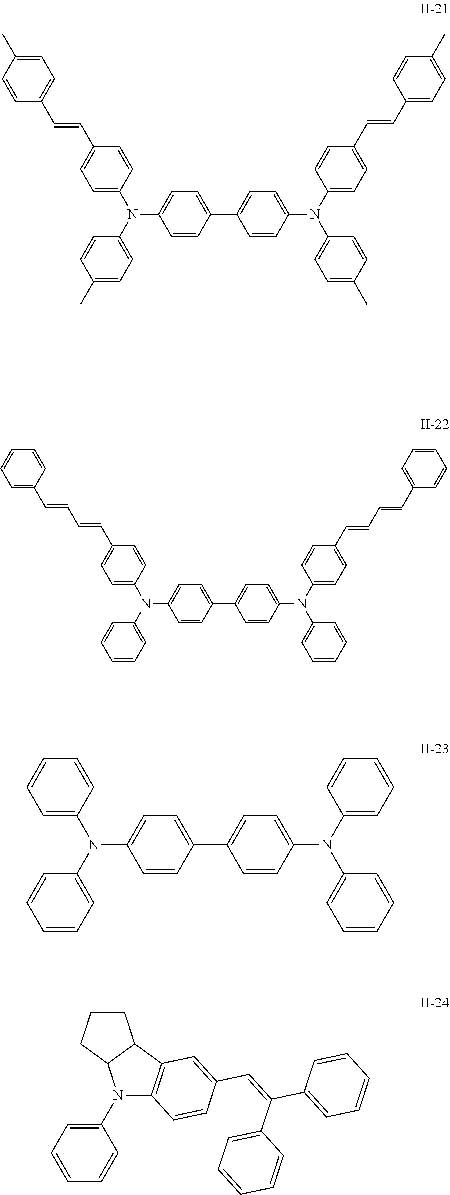 [SMILES: Cc1ccc(/C=C/c2ccc(N(c3ccc(C)cc3)c3ccc(-c4ccc(N(c5ccc(C)cc5)c5ccc(/C=C/c6ccc(C)cc6)cc5)cc4)cc3)cc2)cc1 ; C(/C=C/c1ccc(N(c2ccccc2)c2ccc(-c3ccc(N(c4ccccc4)c4ccc(/C=C/C=C/c5ccccc5)cc4)cc3)cc2)cc1)=C\c1ccccc1 ; c1ccc(N(c2ccccc2)c2ccc(-c3ccc(N(c4ccccc4)c4ccccc4)cc3)cc2)cc1 ; C(=C(c1ccccc1)c1ccccc1)c1ccc2c(c1)C1CCCC1N2c1ccccc1]

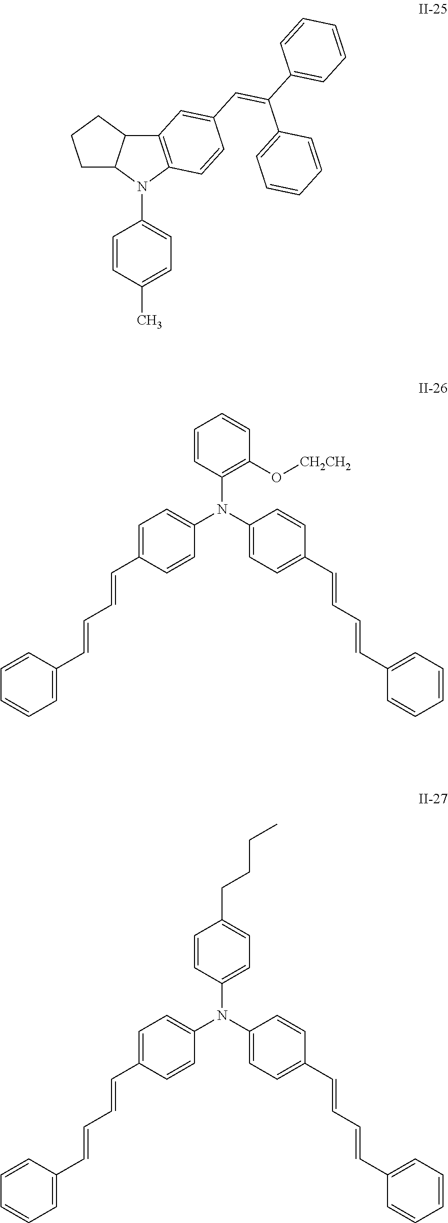

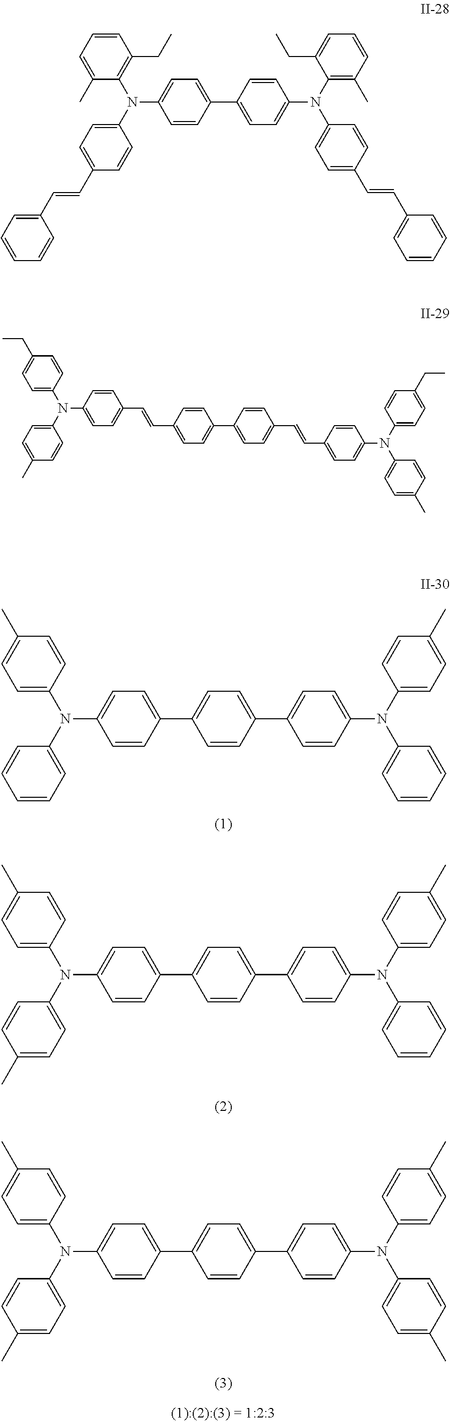 [SMILES: CCc1cccc(C)c1N(c1ccc(/C=C/c2ccccc2)cc1)c1ccc(-c2ccc(N(c3ccc(/C=C/c4ccccc4)cc3)c3c(C)cccc3CC)cc2)cc1 ; CCc1ccc(N(c2ccc(C)cc2)c2ccc(/C=C/c3ccc(-c4ccc(/C=C/c5ccc(N(c6ccc(C)cc6)c6ccc(CC)cc6)cc5)cc4)cc3)cc2)cc1 ; Cc1ccc(N(c2ccccc2)c2ccc(-c3ccc(-c4ccc(N(c5ccccc5)c5ccc(C)cc5)cc4)cc3)cc2)cc1 ; Cc1ccc(N(c2ccccc2)c2ccc(-c3ccc(-c4ccc(N(c5ccc(C)cc5)c5ccc(C)cc5)cc4)cc3)cc2)cc1 ; Cc1ccc(N(c2ccc(C)cc2)c2ccc(-c3ccc(-c4ccc(N(c5ccc(C)cc5)c5ccc(C)cc5)cc4)cc3)cc2)cc1]

Furthermore, as the electron transport material of the charge transport layer 5, one or more kinds of those having the above predetermined electron mobility, and if necessary one or more kinds of electron transport materials other than these examples may be adequately used in combination.

The content of the resin binder in the charge transport layer 5 is suitably from 20 to 90% by mass, and more suitably from 30 to 80% by mass, with respect to the solid content of the charge transport layer 5. The total content of the hole transport material and the electron transport material in the charge transport layer 5 is suitably from 10 to 80% by mass, and more suitably from 20 to 70% by mass, with respect to the solid content of the charge transport layer 5. The ratio of the hole transport material to the electron transport material may range from 100:1 to 100:10.

The charge transport layer 5 preferably has a film thickness within the range of from 3 to 50 μm, more preferably within the range of from 15 to 40 μm, in order to maintain a practically effective surface potential.

Positively Charged Monolayer Photoreceptor:

In the case of the positively-charged monolayer photoreceptor, the monolayer photosensitive layer 3 constitutes the outermost surface layer of the photoreceptor. In the positively-charged monolayer photoreceptor, the monolayer photosensitive layer 3 is mainly composed of a hole transport material and an electron transport material, as the charge generation material and the charge transport material, respectively, as well as a resin binder.

Examples of the resin binder which can be used in the monolayer photosensitive layer 3 include: various types of other polycarbonate resins such as bisphenol A polycarbonates, bisphenol Z polycarbonates, bisphenol A polycarbonate-biphenyl copolymers and bisphenol Z polycarbonate-biphenyl copolymers; polyphenylene resins; polyester resins; polyvinyl acetal resins; polyvinyl butyral resins; polyvinyl alcohol resins; vinyl chloride resins; vinyl acetate resins; polyethylene resins; polypropylene resins; acrylic resins; polyurethane resins; epoxy resins; melamine resins; silicone resins; polyamide resins; polystyrene resins; polyacetal resins; polyarylate resins; polysulfone resins; methacrylate polymers; and copolymers of these resins. Further, the same kind of resins having different molecular weights may be used as a mixture.

Examples of the charge generation material which can be used in the monolayer photosensitive layer 3 include phthalocyanine pigments, azo pigments, anthanthrone pigments, perylene pigments, perinone pigments, polycyclic quinone pigments, squarylium pigments, thiapyrylium pigments, and quinacridone pigments. These charge generation materials can be used singly, or two or more kinds of these materials can be used in combination. In particular, in the photoreceptor according to the present invention, disazo pigments and trisazo pigments are preferably used as azo pigments, N,N′-Bis(3,5-dimethylphenyl)-3,4:9,10-perylenebisdicarbimide is preferably used as a perylene pigment, and metal-free phthalocyanine, copper phthalocyanine and titanyl phthalocyanine are preferably used as phthalocyanine pigments. Further, the use of the following compounds enables to exhibit a markedly improved sensitivity, durability and image quality, and thus is preferred: X-type metal-free phthalocyanine, τ-type metal-free phthalocyanine, ε-type copper phthalocyanine, α-type titanyl phthalocyanine, β-type titanyl phthalocyanine, Y-type titanyl phthalocyanine, amorphous titanyl phthalocyanine, and titanyl phthalocyanines which are disclosed in JPH08-209023A, U.S. Pat. Nos. 5,736,282A and 5,874,570A, and in which the Bragg angle 2θ has a maximum peak at 9.6°, in an X-ray diffraction spectrum using CuKα.

Examples of the hole transport material which can be used in the monolayer photosensitive layer 3 include hydrazone compounds, pyrazoline compounds, pyrazolone compounds, oxadiazole compounds, oxazole compounds, aryl amine compounds, benzidine compounds, stilbene compounds, styryl compounds, poly-N-vinylcarbazoles and polysilanes. These hole transport materials can be used singly, or two or more kinds of these materials can be used in combination. The hole transport material to be used in the present invention is preferably one which has an excellent ability to transport holes generated upon light irradiation, and which is suitable for use in combination with the charge generation material.

As the electron transport material of the monolayer photosensitive layer 3, one or more kinds of those having the above predetermined electron mobility, and if necessary one or more kinds of electron transport materials other than these examples may be adequately used in combination.

The content of the resin binder in the monolayer photosensitive layer 3 is suitably from 10 to 90% by mass, and more suitably from 20 to 80% by mass, with respect to the solid content of the monolayer photosensitive layer 3. The content of the charge generation material in the monolayer photosensitive layer 3 is suitably from 0.1 to 20% by mass, and more suitably from 0.5 to 10% by mass, with respect to the solid content of the monolayer photosensitive layer 3. The content of the hole transport material in the monolayer photosensitive layer 3 is suitably from 3 to 80% by mass, and more suitably from 5 to 60% by mass, with respect to the solid content of the monolayer photosensitive layer 3. The content of the electron transport material in the monolayer photosensitive layer 3 is suitably from 1 to 50% by mass, and more suitably from 5 to 40% by mass, with respect to the solid content of the monolayer photosensitive layer 3.

The monolayer photosensitive layer 3 preferably has a film thickness within the range of from 3 to 100 μm, and more preferably within the range of from 5 to 40 μm, in order to maintain a practically effective surface potential.

Positively-Charged Laminated Photoreceptor:

In the positively-charged laminated photoreceptor, the photosensitive layer includes: the charge transport layer 5; and the charge generation layer 4; in this order from the side of the electrically conductive support 1. In the case of the positively-charged laminated photoreceptor, the charge generation layer 4 constitutes the outermost surface layer of the photoreceptor. In the positively-charged laminated photoreceptor, the charge transport layer 5 is mainly composed of a hole transport material and a resin binder. As such a hole transport material and a resin binder, it is possible to use the same materials as those exemplified for the charge transport layer 5 in the negatively-charged laminated photoreceptor. The film thickness of the charge transport layer 5 may also be the same as those described for the negatively-charged laminated photoreceptor.

The content of the resin binder in the charge transport layer 5 is suitably from 20% to 90% by mass, and more suitably from 30% to 80% by mass, with respect to the solid content of the charge transport layer 5. The content of the hole transport material in the charge transport layer 5 is suitably from 10% to 80% by mass, and more suitably from 20 to 70% by mass, with respect to the solid content of the charge transport layer 5.

The charge generation layer 4, which is provided on the charge transport layer 5, is mainly composed of a hole transport material and an electron transport material, as the charge generation material and the charge transport material, respectively, as well as a resin binder. As the charge generation material, the hole transport material, the electron transport material, and the resin binder, it is possible to use the same materials as those exemplified for the monolayer photosensitive layer 3 in the monolayer photoreceptor. The contents of the respective materials and the film thickness of the charge generation layer 4 may also be the same as those described for the monolayer photosensitive layer 3 in the monolayer photoreceptor.

In the present invention, a leveling agent such as a silicone oil or a fluorine-based oil can be incorporated into any of the laminated and monolayer photosensitive layers, for the purposes of improving the leveling properties of the formed film, and imparting lubricity. Further, a plurality of kinds of inorganic oxides may be contained for the purposes of adjusting film hardness, reducing friction coefficient, imparting lubricity, and the like. The photosensitive layer may also contain the fine particles of: metal oxides such as silica, titanium oxide, zinc oxide, calcium oxide, alumina, and zirconium oxide; metal sulfates such as barium sulfate, and calcium sulfate; and metal nitrides such as silicon nitride, and aluminium nitride, or, fluorine resin particles such as ethylene tetrafluoride resins, fluorine comb-like graft polymerized resins, and the like. Furthermore, it is also possible to incorporate other known additives, as required, to the extent that the electrophotographic properties are not markedly impaired.

In addition, an antidegradant, such as an antioxidant or a photostabilizer, can be incorporated into the photosensitive layer, for the purpose of improving environmental resistance and stability to harmful light. Examples of the compound to be used for such a purpose include: chromanol derivatives such as tocopherol, as well as esterified compounds, polyarylalkane compounds, hydroquinone derivatives, etherified compounds, dietherified compounds, benzophenone derivatives, benzotriazole derivatives, thioether compounds, phenylenediamine derivatives, phosphonic acid esters, phosphorous acid esters, phenolic compounds, hindered phenol compounds, linear amine compounds, cyclic amine compounds and hindered amine compounds.

Method for Producing Photoreceptor:

The method for producing a photoreceptor of the present invention includes: an anodic oxidation step of forming an anodic oxide film on a surface of an electrically conductive support; and a post-treatment step of exposing the electrically conductive support after the anodic oxidation step to a steam atmosphere, wherein a quantity of the steam atmosphere in the post-treatment step is 60 RH %·h or more. This makes it possible to obtain an electrically conductive support 1 capable of suppressing the occurrence of a leak phenomenon even when an electron transport material with a relatively high electron mobility is used for the photosensitive layer. Here, the quantity of a steam atmosphere is a value represented by the ratio of: the total steam quantity ((g/m³)·RH %·h) in the steam atmosphere, which is represented by the product of steam quantity per unit volume ((g/m³)·RH %), which is the product of the quantity of saturated steam (g/m³) times relative humidity (RH %) in the steam atmosphere, times the processing time (h) of the post-treatment step; to the quantity of saturated steam (g/m³) at a temperature of 323K. The quantity of a steam atmosphere is found as the product of relative humidity (RH %) times time (h).

Conditions in the post-treatment step for exposing the electrically conductive support 1 to a steam atmosphere include the quantity of a steam atmosphere of 60 RH %·h or more, preferably 90 RH %·h or more, and further preferably 180 RH %·h or more. The quantity of a steam atmosphere, which is lower than the above range, makes it difficult to adjust the admittance value within the above range so as to improve the pressure resistance. Further, the quantity of a steam atmosphere, which is higher than the above range, aggravates the cost performance. Therefore, the quantity of the steam atmosphere is preferably set to less than 2000 RH %·h, further preferably 1500 RH %·h or less, and particularly preferably 720 RH %·h or less.

Treatment conditions of the post-treatment step may include the quantity of a steam atmosphere which is within the above range, a specific temperature that can be selected from a temperature range of 293K or higher and 333K or lower, humidity that can be selected from a relative humidity range of 20 RH % or more and 90 RH % or less, and preferably 30 RH % or more and 50 RH % or less, for example, and a processing time that can be selected from a range of 1 or more hours and 50 or less hours, and preferably 3 or more hours and 30 or less hours, for example.

In the embodiment of the present invention, a photoreceptor can be produced by forming a photosensitive layer on the electrically conductive support 1 obtained after the above post-treatment, in accordance with an ordinary method, for example, by a dip coating method or the like, with an undercoat layer interposed therebetween and containing a resin material, as desired.

Electrophotographic Device:

The photoreceptor of the present invention provides expected effects when used in various types of machine processes. Specifically, as a charging process and a transferring process, both contact charging systems using a charging member such as a roller or a brush, and non-contact charging systems using a corotron, a scorotron or the like can be used, and as a development process, both contact and non-contact development systems, using a non-magnetic single-component development system, a magnetic single-component development system, a magnetic two-component development system, and the like, can be used, so that sufficient effects can be obtained.

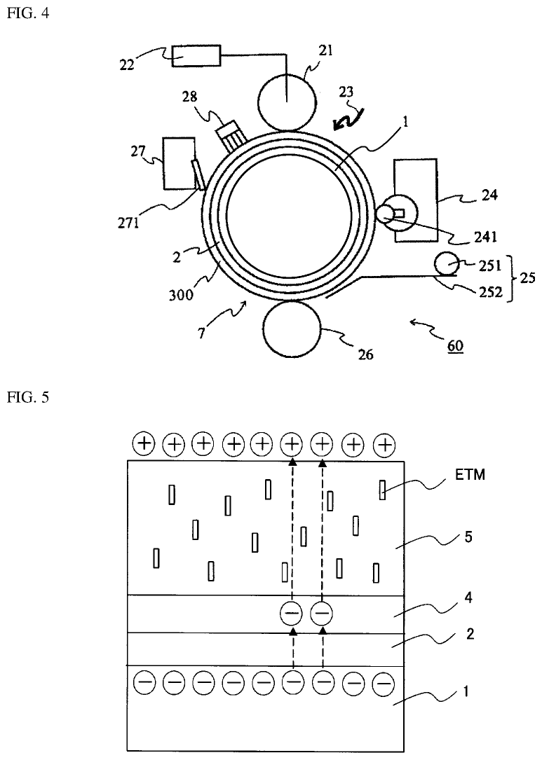

FIG. 4 shows a schematic diagram of one configuration example of the electrophotographic device according to the present invention. An electrophotographic device 60 shown in FIG. 2 includes a photoreceptor 7 including: an electrically conductive support 1; and an undercoat layer 2 and a photosensitive layer 300 coated on the outer peripheral surface of the electrically conductive support 1. The electrophotographic device 60 is composed of: a charging member 21 disposed at the outer peripheral edge of the photoreceptor 7; a high voltage power supply 22 for supplying a voltage to be applied to the charging member 21; an image exposure member 23; a developer 24 including a developing roller 241; a paper feed member 25 including a paper feed roller 251 and a paper feed guide 252; and a transfer charging unit (direct charging type) 26. The electrophotographic device 60 may further include: a cleaning device 27 including a cleaning blade 271; and a destaticizing member 28. Further, the electrophotographic device 60 can be a color printer.

The electrophotographic device of the present invention includes devices for performing at least a charging process and a transferring process, and the above photoreceptor of the present invention, wherein at least one of the charging process and the transferring process is a contact type process. As described above, the photoreceptor including a photosensitive layer containing an electron transport material is problematic in that particularly when used for an electrophotographic device having a contact type charging process or transferring process, a leak phenomenon tends to occur. Hence, the present invention is useful in such an electrophotographic device.

Further when at least one of the charging process and the transferring process is a positive charging and contact type process, a leak phenomenon occurs more easily in a photoreceptor including a photosensitive layer containing an electron transport material. The reason thereof is described using a negatively-charged photoreceptor as an example. FIG. 5 is an explanatory diagram showing the transfer of electric charges in a negatively-charged photoreceptor.

In the negatively-charged photoreceptor, in general, the surface of the charge transport layer 5, that is the surface of the photoreceptor is negatively charged, and the electrically conductive support 1 is positively charged. Accordingly, the undercoat layer 2 is provided with a blocking function, thereby suppressing the injection of positive electric charges from the electrically conductive support 1 to the photosensitive layer. In contrast, as shown in FIG. 5, when the surface of a negatively-charged photoreceptor is positively charged, the surface of the electrically conductive support 1 is negatively charged. The undercoat layer 2 has no function for blocking negative electric charges, and thus negative electric charges are easily transferred from the electrically conductive support 1 to the charge generation layer 4. Furthermore, if the charge transport layer 5 contains an electron transport material ETM capable of transporting electrons (negative electric charges), facilitating electron transfer from the charge generation layer 4 to the surface of the photoreceptor. As described above, in an electrophotographic device containing a process of positively charging the surface of a photoreceptor in which the charge transport layer 5 contains an electron transport material (ETM), electric charges are easily transferred from the electrically conductive support 1 to the surface of the photoreceptor, and this is particularly significant when the electron transport material ETM has high electron mobility. Such a mechanism causes a decrease in pressure resistance in a photoreceptor including a photosensitive layer containing an electron transport material, and thus a leak phenomenon is more likely to occur.

Particularly, when at least one of the charging process and the transferring process is a contact-type roller member, and linear velocity in the rotation direction of the surface of the contact-type roller member is 200 mm/sec or more, further 260 mm/sec or more, or 260 mm/sec or more and 500 mm/sec or less, a leak phenomenon is considered to occur more easily because of a short time for contact of each portion of the photoreceptor and the roller member. Hence, applying the present invention is more useful. In an electrophotographic process with high linear velocity, charging or transfer voltage (electric current) may be increased and further the electrical resistance of a roller member may be decreased. Particularly, a roller member with low resistance is applied to a photoreceptor for which an electron transport material has been added to the photosensitive layer as a measure against light-induced fatigue, and then the surface of the photoreceptor is positively charged, so that electrons are injected from the electrically conductive support, facilitating leak occurrence. In addition, the roller member and the photoreceptor may be rotated together.

The value of the resistance of the above contact-type roller member to be used for the charging process or the transferring process in an electrophotographic device of the embodiment of the present invention can range from 10⁵ to 10⁷ Ω·cm, for example.

### EXAMPLES

Specific embodiments of the present invention will now be described in further detail, with reference to Examples. The present invention is in no way limited by the following Examples, as long as the gist of the present invention is not deviated.

A cylindrical electrically conductive support with an outer diameter of 30 mm containing an aluminum alloy was degreased using a degreasing agent (Top al-clean 101: manufactured by Okuno Chemical Industries Co., Ltd.) at a concentration of 30 g/l, a liquid temperature of 60° C. for 3 minutes, and then rinsed with pure water.

Subsequently, anodic oxidation treatment was performed in a processing vessel with a free sulfuric acid concentration of 180 g/l, an aluminum ion concentration of 3 g/l, and a liquid temperature of 20° C. under conditions of electric current density of 0.74 A/dm², thereby forming an anodic oxide film having a thickness of 8 μm on the outer surface of the electrically conductive support. Next the resultant was washed with water, subjected to pore sealing treatment using a treatment agent shown in the following table, and then washed with water.

The thus obtained electrically conductive support was stored according to conditions described in the following table under a steam atmosphere. Subsequently, the admittance value of the surface of the obtained electrically conductive support was measured in accordance with JIS H8683-3:2013 using ANOTEST® (manufactured by Helmut Fischer GmbH). With the use of the electrically conductive support, a negatively-charged laminated photoreceptor was produced according to the following description.

P-vinylphenol resin (trade name—Maruka Linker MH-2—manufactured by Maruzen Petrochemical CO, LTD.) (15 parts by mass), 10 parts by mass of N-butylated melamine resin (trade name—U-VAN 2021: manufactured by Mitsui Chemicals, Inc.), and 75 parts by mass of titanium oxide fine particles subjected to aminosilane treatment were each dissolved or dispersed in 750/150 (methanol and butanol) parts by mass of a mixture (solvent) to prepare a coating liquid for forming an undercoat layer. The above electrically conductive support was dipped in and then removed from the coating liquid, thereby forming a coating film on the outer periphery. The resultant was dried at a temperature of 130° C. for 30 minutes, thereby forming an undercoat layer with a film thickness of 3 μm.

Next, a coating liquid for forming a charge generation layer was prepared by dispersing 15 parts by mass of Y titanyl phthalocyanine as a charge generation material according to JPS64-17066A (U.S. Pat. No. 4,898,799A), and, 15 parts by mass of polyvinyl butyral (S-LEC B BX-1, manufactured by SEKISUI CHEMICAL CO., LTD.) as a resin binder in 600 parts by mass of dichloromethane using a sand mill dispersing machine for 1 hour. The undercoat layer was coated with the coating liquid by dip coating. The resultant was dried at a temperature of 80° C. for 30 minutes, thereby forming a charge generation layer with a film thickness of 0.3 μm.

Furthermore, a coating liquid for forming a charge transport layer was prepared by dissolving 72 parts by mass of a compound represented by the following structural formula (HT1) as a hole transport material, 8 parts by mass of an electron transport material described in the following table, and 120 parts by mass of a polycarbonate resin (Lupizeta® PCZ-500, manufactured by MITSUBISHI GAS CHEMICAL COMPANY, INC.) as a resin binder in 900 parts by mass of dichloromethane, and then adding 0.1 parts by mass of silicone oil (KP-340, manufactured by Shin-Etsu Polymer Co., Ltd.). The charge generation layer was coated with the coating liquid by dip coating. The resultant was dried at a temperature of 100° C. for 60 minutes to form a charge transport layer with a film thickness of 25 μm, thereby preparing an electrophotographic photoreceptor.

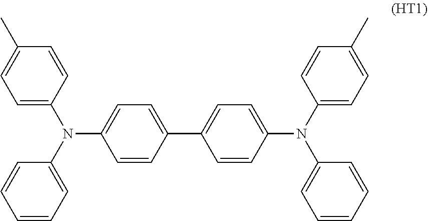 [SMILES: Cc1ccc(N(c2ccccc2)c2ccc(-c3ccc(N(c4ccccc4)c4ccc(C)cc4)cc3)cc2)cc1]

Method for Evaluating Pressure Resistance:

Twenty (20) gold electrodes were fixed with a tape on the surface of each photoreceptor, +3 Kv was applied from the gold electrodes for 5 minutes, and then the presence or the absence of a leak occurrence was confirmed. Evaluation was made for 5 photoreceptors, and then leak incidence was found by percentage.

Method for Evaluating Photoresistance:

Each photoreceptor was covered with black paper with openings, irradiated with a white fluorescent lamp having illuminance adjusted to be 1000 lux for 10 minutes. The parts of the surface of the photoreceptor corresponding to the openings were irradiated with light but parts of the same covered by black paper (non-irradiation parts) were not irradiated with light. With the use of a photoreceptor electric characteristic measurement system CYNTHIA 93FE, (manufactured by GENTEC CO., LTD.), under an environment of a temperature 23° C. and relative humidity of 50%, a voltage to be applied was adjusted using a scorotron charging system, charging was performed in such a manner that the photoreceptor surface potential of the non-irradiation parts was −300 V, thereby measuring a difference in surface potential between the non-irradiation parts and the irradiation part. A case when the difference was 20 V or less was determined as ∘ (good), and a case when the difference was 20 V or more was determined as x (poor).

Method for Evaluating Cost Performance:

Each photoreceptor was evaluated for cost performance according to the following criteria.

⊚: case of no storage under a steam atmosphere.

∘: case when the quantity of a steam atmosphere is less than 2000 RH %·h.

x: case when the quantity of a steam atmosphere is 2000 RH %·h or more.

These results are also shown in the following table.

TABLE 1

| | | Electron | | | Steam atmosphere storage conditions | | | | Pressure | | |
|---|---|---|---|---|---|---|---|---|---|---|---|
| | Value Y | transport material | | | | | | Quantity | resistance | | |
| | (admittance | | Mobility*² | Pore | Tempera- | Relative | | of steam | (leak | | |
| | value) | | (×10⁻⁷ | sealing | ture | humidity | Retention | atmosphere*³ | incidence) | Light | Cost |
| | (μS) | Type*⁴ | cm²/V/sec) | agent | (K) | (RH%) | time(h) | (RH% · h) | (%) | resistance | performance |
| Comparative | 100 | ET | 4.5 | Nickel | — | — | — | 0 | 30 | ○ | ⊚ |
| Example 1 | | 2-3 | | acetate*¹ | | | | | | | |
| Comparative | 95 | ET | 4.5 | Pure | — | — | — | 0 | 24 | ○ | ⊚ |
| Example 2 | | 2-3 | | water | | | | | | | |
| Comparative | 80 | ET | 4.5 | Pure | 323 | 30 | 1 | 30 | 10 | ○ | ○ |
| Example 3 | | 2-3 | | water | | | | | | | |
| Comparative | 72 | ET | 4.5 | Pure | 323 | 30 | 2 | 60 | 4 | ○ | ○ |
| Example 4 | | 2-3 | | water | | | | | | | |
| Comparative | 72 | ET | 28 | Pure | 323 | 30 | 2 | 60 | 10 | ○ | ○ |
| Example 5 | | 1-4 | | water | | | | | | | |
| Comparative | 72 | ET | 15 | Pure | 323 | 30 | 2 | 60 | 6 | ○ | ○ |
| Example 6 | | 3-4 | | water | | | | | | | |
| Comparative | 72 | E-2 | 0.7 | Pure | 323 | 30 | 2 | 60 | 0 | × | ○ |
| Example 7 | | | | water | | | | | | | |
| Comparative | 72 | E-5 | 1.5 | Pure | 323 | 30 | 2 | 60 | 2 | ○ | ○ |
| Example 8 | | | | water | | | | | | | |
| Comparative | 15 | ET | 4.5 | Pure | 323 | 50 | 50 | 2500 | 0 | ○ | × |
| Example 9 | | 2-3 | | water | | | | | | | |
| Example 1 | 60 | ET | 4.5 | Nickel | 323 | 30 | 3 | 90 | 0 | ○ | ○ |
| | | 2-3 | | acetate*¹ | | | | | | | |
| Example 2 | 60 | ET | 28 | Nickel | 323 | 30 | 3 | 90 | 0 | ○ | ○ |
| | | 1-4 | | acetate*¹ | | | | | | | |
| Example 3 | 43 | ET | 4.5 | Pure | 323 | 30 | 6 | 180 | 0 | ○ | ○ |
| | | 2-3 | | water | | | | | | | |
| Example 4 | 35 | ET | 4.5 | Nickel | 323 | 30 | 24 | 720 | 0 | ○ | ○ |
| | | 2-3 | | acetate*¹ | | | | | | | |
| Example 5 | 25 | ET | 4.5 | Pure | 323 | 50 | 30 | 1500 | 0 | ○ | ○ |
| | | 2-3 | | water | | | | | | | |
| Example 6 | 60 | E-5 | 1.5 | Nickel | 323 | 30 | 3 | 90 | 0 | ○ | ○ |
| | | | | acetate*¹ | | | | | | | |

*¹Treated at 90° C. for 10 minutes using nickel acetate with a concentration of 6 g/liter.
*²Electron mobility when field intensity was set to 20 V/μm.
*³Found as the product of relative humidity (RH%) times time (h).
*⁴Following compounds were used as E-2 and E-5:

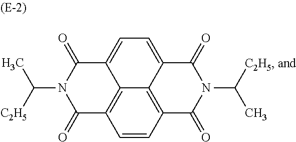

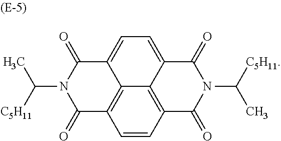

As shown in the results in the above table, it was confirmed that through the use of an electrically conductive support having an anodic oxide film and satisfying the admittance value according to the present invention, the occurrence of a leak phenomenon can be suppressed while increasing pressure resistance and maintaining good cost performance, even when an electron transport material having a relatively high electron mobility is used for a photosensitive layer.

### DESCRIPTION OF SYMBOLS

1 Electrically conductive support
2 Undercoat layer
3 Monolayer photosensitive layer
4 Charge generation layer
5 Charge transport layer
7 Photoreceptor
21 Charging member
22 High voltage power supply
23 Image exposure member
24 Developer
241 Developing roller
25 Paper feed member
251 Paper feed roller
252 Paper feed guide
26 Transfer charging unit (direct charging type)
27 Cleaning device
271 Cleaning blade
28 Destaticizing member
60 Electrophotographic device
300 Photosensitive layer

What is claimed is:

1. An electrophotographic photoreceptor that is a negatively-chargeable, laminated electrophotographic photoreceptor, comprising:
an electrically conductive support containing an aluminum alloy;
an anodic oxide film formed on a surface of the electrically conductive support; and
a photosensitive layer formed on the anodic oxide film,
wherein the photosensitive layer contains an electron transport material having an electron mobility of 10⁻⁷ cm²/V/sec or more when field intensity is set to 20 V/μm, and
wherein the surface of the electrically conductive support having the anodic oxide film formed hereon has an admittance value of 25 μS or more and 60 μS or less.

2. The electrophotographic photoreceptor according to claim 1, wherein the electron transport material is selected from at least one compound represented by general formulae (ET1) to (ET3) below and a compound represented by structural formula (E-5) below: 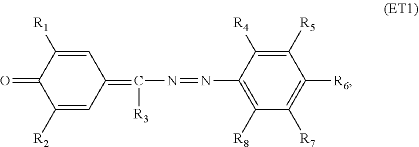
where R₁ and R₂ are the same or different, and each represents a hydrogen atom, a C1-C12 alkyl group, a C1-C12 alkoxy group, an aryl group which may have a substituent, a cycloalkyl group, an aralkyl group which may have a substituent, or, an alkyl halide group, R₃ represents a hydrogen atom, a C1-C6 alkyl group, a C1-C6 alkoxy group, an aryl group which may have a substituent, a cycloalkyl group, an aralkyl group which may have a substituent, or, an alkyl halide group, R₄ to R₈ are the same or different, and each represents a hydrogen atom, a halogen atom, a C1-C12 alkyl group, a C1-C12 alkoxy group, an aryl group which may have a substituent, an aralkyl group which may have a substituent, a phenoxy group which may have a substituent, an alkyl halide group, a cyano group, or, a nitro group, or, two or more groups may bind to each other to form a ring, and the substituent represents a halogen atom, a C1-C6 alkyl group, a C1-C6 alkoxy group, a hydroxyl group, a cyano group, an amino group, a nitro group, or, an alkyl halide group; 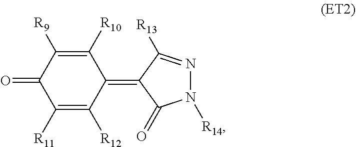
where R₉ to R₁₄ are the same or different, and each represents a hydrogen atom, a halogen atom, a cyano group, a nitro group, a hydroxyl group, a C1-C12 alkyl groups, a C1-C12 alkoxy group, an aryl group which may have a substituent, a heterocyclic group which may have a substituent, an ester group, a cycloalkyl group, an aralkyl group which may have a substituent, an allyl group, an amide group, an amino group, an acyl group, an alkenyl group, an alkynyl group, a carboxyl group, a carbonyl group, a carboxylic acid group, or, an alkyl halide group, and the substituent represents a halogen atom, a C1-C6 alkyl group, a C1-C6 alkoxy group, a hydroxyl group, a cyano group, an amino group, a nitro group, or, an alkyl halide group; 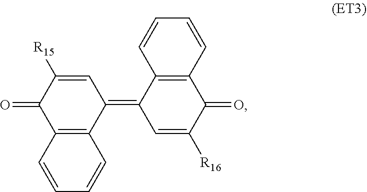
where R₁₅ and R₁₆ are the same or different, and each represents a hydrogen atom, a halogen atom, a cyano group, a nitro group, a hydroxyl group, a C1-C12 alkyl group, a C1-C12 alkoxy group, an aryl group which may have a substituent, a heterocyclic group which may have a substituent, an ester group, a cycloalkyl group, an aralkyl group which may have a substituent, an allyl group, an amide group, an amino group, an acyl group, an alkenyl group, an alkynyl group, a carboxyl group, a carbonyl group, a carboxylic acid group, or, an alkyl halide group, and the substituent represents a halogen atom, a C1-C6 alkyl group, a C1-C6 alkoxy group, a hydroxyl group, a cyano group, an amino group, a nitro group, or, an alkyl halide group; and

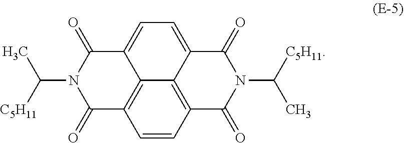

3. A method for producing the electrophotographic photoreceptor according to claim 1, comprising:
forming the anodic oxide film on the surface of the electrically conductive support using anodic oxidation; and
exposing the electrically conductive support after anodic oxidation to a steam atmosphere as a post-treatment,
wherein the steam atmosphere in the post-treatment is present in a quantity effective to provide 60 RH %·h or more, and
wherein the quantity of the steam atmosphere is a value represented by a ratio of (a) total steam quantity ((g/m³)·RH %·h) in the steam atmosphere, which is represented by a product of steam quantity per unit volume ((g/m³)·RH %), which is a product of a quantity of saturated steam (g/m³) times relative humidity (RH %) in the steam atmosphere, times a processing time (h) of the above post-treatment to (b) the quantity of saturated steam (g/m³) at a temperature of 323K.

4. An electrophotographic device, comprising:
the electrophotographic photoreceptor according to claim 1,
a charging device for charging the electrophotographic photoreceptor; and
a transferring device for transferring an electrophotographic image generated on the electrophotographic photoreceptor,
wherein the charging device or the transferring device is a contact-type device or both the charging device and the transferring device are contact-type devices.

5. The electrophotographic device according to claim 4, wherein the charging device or the transferring device is a positive-charging, contact-type device or both the charging device and the transferring device are positive-charging, contact-type devices.

6. The electrophotographic device according to claim 4, wherein the charging device or the transferring device includes a contact-type roller member or both the charging device and the transferring device include a respective contact-type roller member, and each contact-type roller member has a surface having a linear velocity in a rotation direction that is 200 mm/sec or more.
